(19) United States
(12) Patent Application Publication
(10) Pub. No.: US 2018/0049196 A1
(43) Pub. Date: Feb. 15, 2018

(54) COMBINATION OF SINGLE-TONE AND MULTIPLE-TONE SIGNALING IN SIDELINK COMMUNICATIONS

(71) Applicant: QUALCOMM Incorporated, San Diego, CA (US)

(72) Inventors: Piyush Gupta, Bridgewater, NJ (US); Junyi Li, Chester, NJ (US); Chong Li, Weehawken, NJ (US)

(21) Appl. No.: 15/436,648

(22) Filed: Feb. 17, 2017

Related U.S. Application Data
(60) Provisional application No. 62/372,724, filed on Aug. 9, 2016.

(51) Int. Cl. H04W 72/04

(52) U.S. Cl. CPC H04W 72/0453; H04W 72/0406

(57) ABSTRACT

Aspects of the disclosure relate to a sidelink signaling mechanism that provides for a combination of single-tone and multiple-tone signaling to reduce overhead, while ensuring reliable signaling. In some examples, a sidelink request signal, such as a source transmit signal (STS), may be a single-tone signal, and a sidelink confirmation signal, such as a destination receive signal (DRS), may be a multiple-tone signal. In other examples, the request signal may be a multiple-tone signal, and the confirmation signal may be a single-tone signal.

### PRIORITY CLAIM

This application claims priority to and the benefit of provisional patent application no. 62/372,724, filed in the United States Patent and Trademark Office on Aug. 9, 2016, the entire content of which is incorporated herein by reference as if fully set forth below in its entirety and for all applicable purposes.

### TECHNICAL FIELD

The technology discussed herein relates, generally, to wireless communication systems, and, more particularly, to wireless communication using a sidelink-centric slot. Embodiments can provide and enable techniques for reducing overhead in sidelink signaling.

### INTRODUCTION

In many existing wireless communication systems, a cellular network is implemented by enabling wireless user equipment to communicate with another by signaling with a nearby base station or cell. As a user equipment moves across the service area, handovers take place such that each user equipment maintains communication with one another via its respective best cell.

Another scheme for a wireless communication system is frequently referred to as a mesh or peer to peer (P2P) network, whereby wireless user equipment may signal one another directly, rather than via an intermediary base station or cell.

Somewhat in between these schemes is a system configured for sidelink signaling. With sidelink signaling, a wireless user equipment communicates in a cellular system, generally under the control of a base station. However, the wireless user equipment is further configured for sidelink signaling directly between user equipment without passing through the base station.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure describe a sidelink signaling mechanism that provides for a combination of single-tone and multiple-tone signaling to reduce overhead, while ensuring reliable signaling. In some examples, a sidelink request signal, such as one or more of a direction selection signal (DSS) and a source transmit signal (STS) signal, may be a single-tone signal, and a sidelink confirmation signal, such as a destination receive signal (DRS), may be a multiple-tone signal. In other examples, the request signal may be a multiple-tone signal (e.g., at least the STS), while the confirmation signal may be a single-tone signal. In some examples, the single-tone signals are analog signals, while the multiple-tone signals are digital signals.

In one aspect of the disclosure, a method of sidelink wireless communication is disclosed. The method includes transmitting a request signal indicating a requested duration of time for a transmitting device to utilize a sidelink channel to transmit a sidelink signal, and receiving a confirmation signal from a receiving device indicating availability of the sidelink channel for the requested duration of time. One of the request signal or the confirmation signal is a single-tone signal, while the other is a multiple-tone signal.

Another aspect of the disclosure provides a device for sidelink wireless communication. The device includes a processor, a transceiver communicatively coupled to the processor, and a memory communicatively coupled to the processor. The processor is configured to transmit a request signal indicating a requested duration of time for the device to utilize a sidelink channel to transmit a sidelink signal, and receive a confirmation signal from an additional device indicating availability of the sidelink channel for the requested duration of time. One of the request signal or the confirmation signal is a single-tone signal, while the other is a multiple-tone signal.

Another aspect of the disclosure provides an apparatus for sidelink wireless communication. The apparatus includes means for transmitting a request signal indicating a requested duration of time for a transmitting device to utilize a sidelink channel to transmit a sidelink signal, and means for receiving a confirmation signal from a receiving device indicating availability of the sidelink channel for the requested duration of time. One of the request signal or the confirmation signal is a single-tone signal, while the other is a multiple-tone signal.

Examples of additional aspects of the disclosure follow. In some aspects of the disclosure, the request signal includes a primary request signal, such as the DSS, and a secondary request signal, such as the STS signal. The transmitting device may transmit the primary request signal when the transmitting device is a primary device to indicate link direction.

In some aspects of the disclosure, at least one of the primary and secondary request signals is a single-tone signal, and the confirmation signal, such as the DRS signal, is the multiple-tone signal. In examples where both the primary and secondary request signals are single-tone signals, the secondary request signal may include a destination identifier (ID) of the receiving device. For example, the secondary request signal may include a tone ID indicating the destination ID. In this example, the transmitting device may associate with the receiving device and select the tone ID for the receiving device. In addition, the requested duration of time for utilizing the sidelink channel may be fixed.

In examples where the confirmation signal is the multiple-tone signal and at least one of the primary and secondary request signals are single-tone signals, the confirmation signal may include channel quality information (CQI). In some examples, the multiple-tone confirmation signal may include one or more of a signal-to interference-plus-noise ratio (SINR), CQI, a reference signal or a power setting selected to control dimensions of a protection zone and manage interference for the sidelink signal. In some examples, both the confirmation signal and the primary request signal are multiple-tone signals and the secondary request signal is a single-tone signal. In this example, the transmitting device may further transmit a reference signal to enable channel estimation by the receiving device.

In some aspects of the disclosure, the secondary request signal is a multiple-tone signal, the confirmation signal is a single-tone signal or a multiple-tone signal, and the primary request signal is a single-tone signal or a multiple-tone signal. In examples where the confirmation signal is a single-tone signal and the secondary request signal is a multiple-tone signal, the single-tone confirmation signal includes a power set to control dimensions of a protection zone and manage interference for the sidelink signal.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of an access network according to some aspects of the present disclosure.

FIG. 2 is a diagram conceptually illustrating an example of a scheduling entity communicating with one or more scheduled entities according to some aspects of the present disclosure.

FIG. 3 is a diagram illustrating an example of a hardware implementation for a scheduling entity according to some aspects of the present disclosure.

FIG. 4 is a diagram illustrating an example of a hardware implementation for a scheduled entity according to some aspects of the present disclosure.

FIG. 5 is a diagram illustrating an example of a downlink (DL)-centric slot according to some aspects of the present disclosure.

FIG. 6 is a diagram illustrating an example of an uplink (UL)-centric slot according to some aspects of the present disclosure.

FIG. 7 is a diagram illustrating an example of a sidelink-centric slot according to some aspects of the present disclosure.

FIG. 8 is a diagram illustrating an example of multiple concurrent sidelink-centric slots according to some aspects of the present disclosure.

FIG. 9 is a diagram illustrating another example of a sidelink-centric slot according to some aspects of the present disclosure.

FIG. 10 is a diagram illustrating another example of multiple concurrent sidelink-centric slots according to some aspects of the present disclosure.

FIG. 11 is a diagram illustrating yet another example of multiple concurrent sidelink-centric slots according to some aspects of the present disclosure.

FIG. 12 is a diagram illustrating an example of a sidelink-centric slot that utilizes a combination of single-tone and multiple-tone signaling according to some aspects of the present disclosure.

FIG. 13 is a diagram illustrating another example of a sidelink-centric slot that utilizes a combination of single-tone and multiple-tone signaling according to some aspects of the present disclosure.

FIG. 14 is a diagram illustrating another example of a sidelink-centric slot that utilizes a combination of single-tone and multiple-tone signaling according to some aspects of the present disclosure.

FIG. 15 is a flow chart illustrating a process for single-tone and multiple-tone sidelink signaling according to some embodiments.

FIG. 16 is a flow chart illustrating another process for single-tone and multiple-tone sidelink signaling according to some embodiments.

FIG. 17 is a flow chart illustrating a process for utilizing a single-tone request signal in sidelink communications according to some embodiments.

FIG. 18 is a flow chart illustrating a process for utilizing single-tone and multiple-tone sidelink signaling to control the dimensions of a protection zone according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

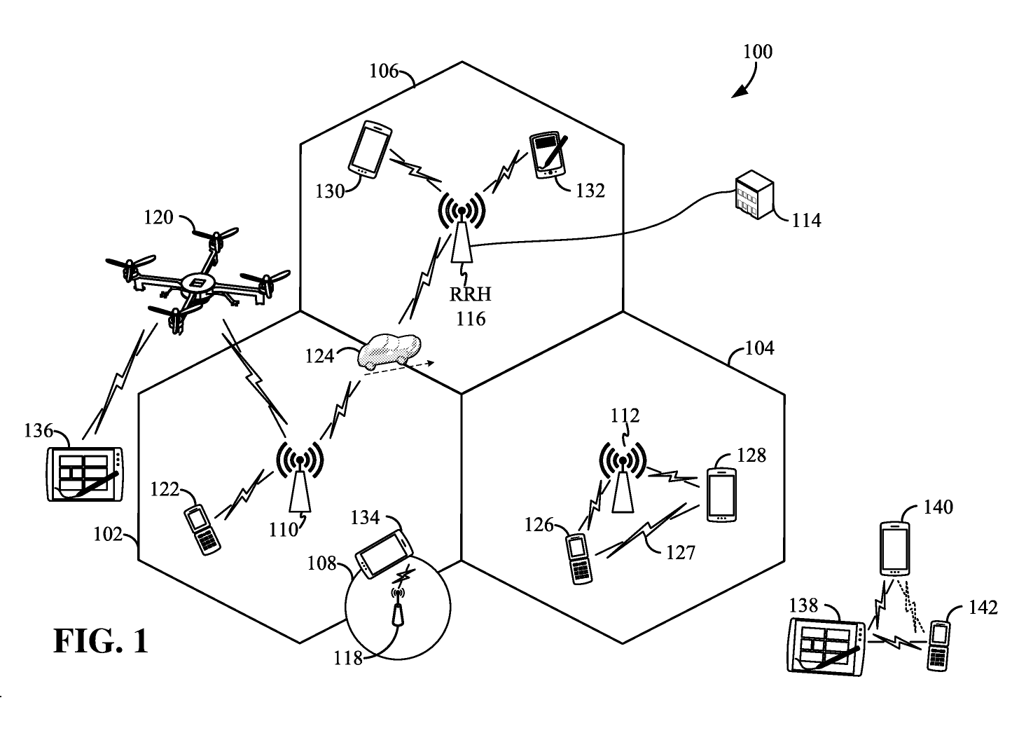

The various concepts presented throughout this disclosure may be implemented across a broad variety of telecommunication systems, network architectures, and communication standards. Referring now to FIG. 1, as an illustrative example without limitation, a simplified schematic illustration of an access network 100 is provided.

The geographic region covered by the access network 100 may be divided into a number of cellular regions (cells) that can be uniquely identified by a user equipment (UE) based on an identification broadcasted over a geographical from one access point or base station. FIG. 1 illustrates macrocells 102, 104, and 106, and a small cell 108, each of which may include one or more sectors. A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a GNodeB or some other suitable terminology.

In FIG. 1, two high-power base stations 110 and 112 are shown in cells 102 and 104; and a third high-power base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the high-power base stations 110, 112, and 114 support cells having a large size. Further, a low-power base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the low-power base station 118 supports a cell having a relatively small size. Cell sizing can be done according to system design as well as component constraints. It is to be understood that the access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In general, base stations may include a backhaul interface for communication with a backhaul portion of the network. The backhaul may provide a link between a base station and a core network, and in some examples, the backhaul may provide interconnection between the respective base stations. The core network is a part of a wireless communication system that is generally independent of the radio access technology used in the radio access network. Various types of backhaul interfaces may be employed, such as a direct physical connection, a virtual network, or the like using any suitable transport network. Some base stations may be configured as integrated access and backhaul (IAB) nodes, where the wireless spectrum may be used both for access links (i.e., wireless links with UEs), and for backhaul links. This scheme is sometimes referred to as wireless self-backhauling. By using wireless self-backhauling, rather than requiring each new base station deployment to be outfitted with its own hard-wired backhaul connection, the wireless spectrum utilized for communication between the base station and UE may be leveraged for backhaul communication, enabling fast and easy deployment of highly dense small cell networks.

The access network 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service user data traffic, and/or relevant QoS for transport of critical service user data traffic.

Within the access network 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with low-power base station 118; and UE 136 may be in communication with mobile base station 120. Here, each base station 110, 112, 114, 118, and 120 may be configured to provide an access point to a core network (not shown) for all the UEs in the respective cells.

In another example, a mobile network node (e.g., quadcopter 120) may be configured to function as a UE. For example, the quadcopter 120 may operate within cell 102 by communicating with base station 110. In some aspects of the disclosure, two or more UE (e.g., UEs 126 and 128) may communicate with each other using peer to peer (P2P) or sidelink signals 127 without relaying that communication through a base station (e.g., base station 112).

Unicast or broadcast transmissions of control information and/or traffic information from a base station (e.g., base station 110) to one or more UEs (e.g., UEs 122 and 124) may be referred to as downlink (DL) transmission, while transmissions of control information and/or traffic information originating at a UE (e.g., UE 122) may be referred to as uplink (UL) transmissions. In addition, the uplink and/or downlink control information and/or traffic information may be time-divided into frames, subframes, slots, and/or symbols. As used herein, a symbol may refer to a unit of time that, in an OFDM waveform, carries one resource element (RE) per subcarrier. A slot may carry 7 or 14 OFDM symbols. A subframe may refer to a duration of 1 ms. Multiple subframes may be grouped together to form a single frame or radio frame. Of course, these definitions are not required, and any suitable scheme for organizing waveforms may be utilized, and various time divisions of the waveform may have any suitable duration.

The air interface in the access network 100 may utilize one or more multiplexing and multiple access algorithms to enable simultaneous communication of the various devices. For example, multiple access for uplink (UL) or reverse link transmissions from UEs 122 and 124 to base station 110 may be provided utilizing time division multiple access (TDMA), code division multiple access (CDMA), frequency division multiple access (FDMA), orthogonal frequency division multiple access (OFDMA), sparse code multiple access (SCMA), single-carrier frequency division multiple access (SC-FDMA), resource spread multiple access (RSMA), or other suitable multiple access schemes. Further, multiplexing downlink (DL) or forward link transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), single-carrier frequency division multiplexing (SC-FDM) or other suitable multiplexing schemes.

Further, the air interface in the access network 100 may utilize one or more duplexing algorithms Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per subframe.

In the radio access network 100, the ability for a UE to communicate while moving, independent of their location, is referred to as mobility. The various physical channels between the UE and the radio access network are generally set up, maintained, and released under the control of a mobility management entity (MME). In various aspects of the disclosure, an access network 100 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In a network configured for UL-based mobility, UL reference signals from each UE may be utilized by the network to select a serving cell for each UE. In some examples, the base stations 110, 112, and 114/116 may broadcast unified synchronization signals (e.g., unified Primary Synchronization Signals (PSSs), unified Secondary Synchronization Signals (SSSs) and unified Physical Broadcast Channels (PBCH)). The UEs 122, 124, 126, 128, 130, and 132 may receive the unified synchronization signals, derive the carrier frequency and slot timing from the synchronization signals, and in response to deriving timing, transmit an uplink pilot or reference signal. The uplink pilot signal transmitted by a UE (e.g., UE 124) may be concurrently received by two or more cells (e.g., base stations 110 and 114/116) within the access network 100. Each of the cells may measure a strength of the pilot signal, and the access network (e.g., one or more of the base stations 110 and 114/116 and/or a central node within the core network) may determine a serving cell for the UE 124. As the UE 124 moves through the access network 100, the network may continue to monitor the uplink pilot signal transmitted by the UE 124. When the signal strength or quality of the pilot signal measured by a neighboring cell exceeds that of the signal strength or quality measured by the serving cell, the network 100 may handover the UE 124 from the serving cell to the neighboring cell, with or without informing the UE 124.

Although the synchronization signal transmitted by the base stations 110, 112, and 114/116 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the access network 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity.

That is, in some examples, a UE may function as a scheduling entity, scheduling resources for one or more scheduled entities (e.g., one or more other UEs). In other examples, sidelink signals may be used between UEs without necessarily relying on scheduling or control information from a base station. For example, UE 138 is illustrated communicating with UEs 140 and 142. In some examples, the UE 138 is functioning as a scheduling entity or a primary sidelink device, and UEs 140 and 142 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 140 and 142 may optionally communicate directly with one another in addition to communicating with the scheduling entity 138.

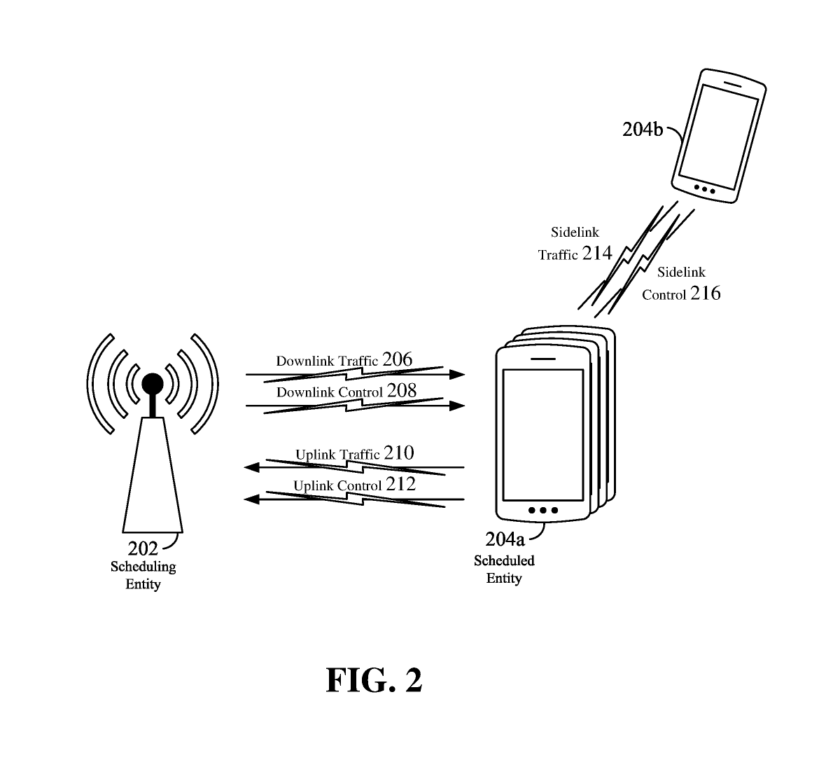

Thus, in a wireless communication network with scheduled access to time-frequency resources and having a cellular configuration, a P2P configuration, or a mesh configuration, a scheduling entity and one or more scheduled entities may communicate utilizing the scheduled resources. Referring now to FIG. 2, a block diagram illustrates a scheduling entity 202 and a plurality of scheduled entities 204 (e.g., 204a and 204b). Here, the scheduling entity 202 may correspond to a base station 110, 112, 114, and/or 118. In additional examples, the scheduling entity 202 may correspond to a UE 138, the quadcopter 120, or any other suitable node in the radio access network 100. Similarly, in various examples, the scheduled entity 204 may correspond to the UE 122, 124, 126, 128, 130, 132, 134, 136, 138, 140, and 142, or any other suitable node in the radio access network 100.

As illustrated in FIG. 2, the scheduling entity 202 may broadcast user data traffic 206 to one or more scheduled entities 204 (the user data traffic may be referred to as downlink user data traffic). In accordance with certain aspects of the present disclosure, the term downlink may refer to a point-to-multipoint transmission originating at the scheduling entity 202. Broadly, the scheduling entity 202 is a node or device responsible for scheduling user data traffic in a wireless communication network, including the downlink transmissions and, in some examples, uplink user data traffic 210 from one or more scheduled entities to the scheduling entity 202. Another way to describe the system may be to use the term broadcast channel multiplexing. In accordance with aspects of the present disclosure, the term uplink may refer to a point-to-point transmission originating at a scheduled entity 204. Broadly, the scheduled entity 204 is a node or device that receives scheduling control information, including but not limited to scheduling grants, synchronization or timing information, or other control information from another entity in the wireless communication network such as the scheduling entity 202.

The scheduling entity 202 may broadcast control information 208 including one or more control channels, such as a PBCH; a PSS; a SSS; a physical control format indicator channel (PCFICH); a physical hybrid automatic repeat request (HARQ) indicator channel (PHICH); and/or a physical downlink control channel (PDCCH), etc., to one or more scheduled entities 204. The PHICH carries HARQ feedback transmissions such as an acknowledgment (ACK) or negative acknowledgment (NACK). HARQ is a technique well known to those of ordinary skill in the art, wherein packet transmissions may be checked at the receiving side for accuracy, and if confirmed, an ACK may be transmitted, whereas if not confirmed, a NACK may be transmitted. In response to a NACK, the transmitting device may send a HARQ retransmission, which may implement chase combining, incremental redundancy, etc.

Uplink user data traffic 210 and/or downlink user data traffic 206 including one or more traffic channels, such as a physical downlink shared channel (PDSCH) or a physical uplink shared channel (PUSCH) (and, in some examples, system information blocks (SIBs)), may additionally be transmitted between the scheduling entity 202 and the scheduled entity 204. Transmissions of the control and user data traffic information may be organized by subdividing a carrier, in time, into suitable slots.

Furthermore, the scheduled entities 204 may transmit uplink control information 212 including one or more uplink control channels (e.g, the physical uplink control channel (PUCCH)) to the scheduling entity 202. Uplink control information (UCI) transmitted within the PUCCH may include a variety of packet types and categories, including pilots, reference signals, and information configured to enable or assist in decoding uplink traffic transmissions. In some examples, the control information 212 may include a scheduling request (SR), i.e., request for the scheduling entity 202 to schedule uplink transmissions. Here, in response to the SR transmitted on the control channel 212, the scheduling entity 202 may transmit downlink control information 208 that may schedule the slot for uplink packet transmissions.

Uplink and downlink transmissions may generally utilize a suitable error correcting block code. In a typical block code, an information message or sequence is split up into information blocks, and an encoder at the transmitting device then mathematically adds redundancy to the information message. Exploitation of this redundancy in the encoded information message can improve the reliability of the message, enabling correction for any bit errors that may occur due to the noise. Some examples of error correcting codes include Hamming codes, Bose-Chaudhuri-Hocquenghem (BCH) codes, turbo codes, low-density parity check (LDPC) codes, Walsh codes, and polar codes. Various implementations of scheduling entities 202 and scheduled entities 204 may include suitable hardware and capabilities (e.g., an encoder and/or decoder) to utilize any one or more of these error correcting codes for wireless communication.

In some examples, scheduled entities such as a first scheduled entity 204a and a second scheduled entity 204b may utilize sidelink signals for direct D2D communication. Sidelink signals may include sidelink user data traffic 214 and sidelink control 216. Sidelink control information 216 may include a source transmit signal (STS), a direction selection signal (DSS), a destination receive signal (DRS), and a physical sidelink HARQ indicator channel (PSHICH). The DSS/STS may provide for a scheduled entity 204 to request a duration of time to keep a sidelink channel available for a sidelink signal; and the DRS may provide for the scheduled entity 204 to indicate availability of the sidelink channel, e.g., for a requested duration of time. An exchange of DSS/STS and DRS (e.g., handshake) may enable different scheduled entities performing sidelink communications to negotiate the availability of the sidelink channel prior to communication of the sidelink user data traffic 214. The PSHICH may include HARQ acknowledgment information and/or a HARQ indicator from a destination device, so that the destination may acknowledge traffic received from a source device.

The channels or carriers illustrated in FIG. 2 are not necessarily all of the channels or carriers that may be utilized between a scheduling entity 202 and scheduled entities 204, and those of ordinary skill in the art will recognize that other channels or carriers may be utilized in addition to those illustrated, such as other traffic, control, and feedback channels.

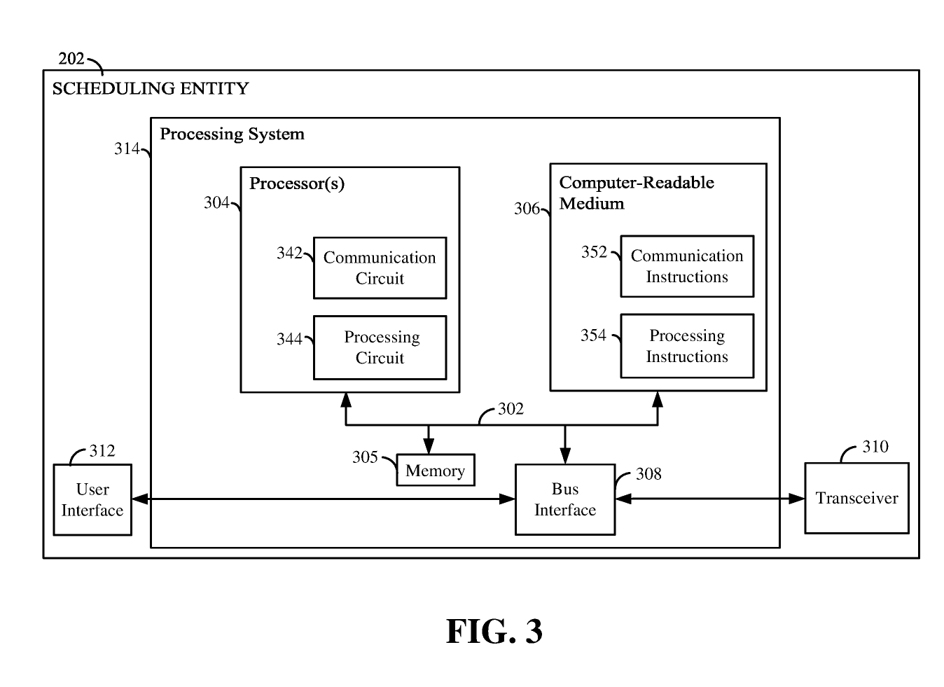

FIG. 3 is a diagram 300 illustrating an example of a hardware implementation for scheduling entity 202 according to aspects of the present disclosure. Scheduling entity 202 may employ a processing system 314. Scheduling entity 202 may be implemented with a processing system 314 that includes one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, scheduling entity 202 may be configured to perform any one or more of the functions described herein. That is, the processor 304, as utilized in scheduling entity 202, may be used or configured to implement any one or more of the processes described herein.

In this example, the processing system 314 may be implemented with a bus architecture, represented generally by the bus 302. The bus 302 may include any number of interconnecting buses and bridges depending on the specific application of the processing system 314 and the overall design constraints. The bus 302 communicatively couples together various circuits including one or more processors (represented generally by the processor 304), a memory 305, and computer-readable media (represented generally by the computer-readable medium 306). The bus 302 may also link various other circuits such as timing sources, peripherals, voltage regulators, and power management circuits. A bus interface 308 provides an interface between the bus 302 and a transceiver 310. The transceiver 310 provides a communication interface or a means for communicating with various other apparatuses over a transmission medium. Depending upon the nature of the apparatus, a user interface 312 (e.g., keypad, display, speaker, microphone, joystick) may also be provided.

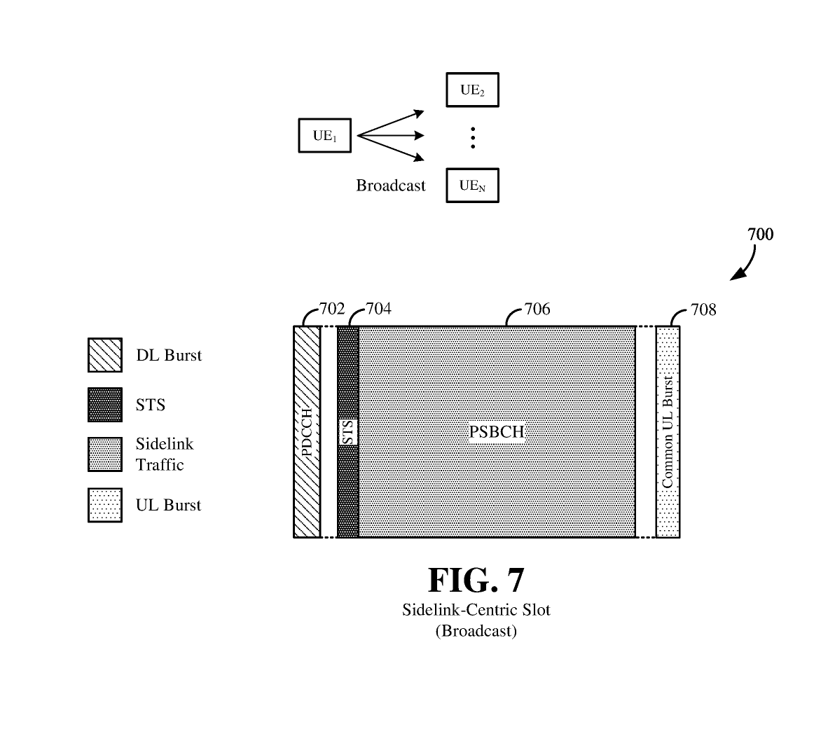

At least one processor 304 is responsible for managing the bus 302 and general processing, including the execution of software stored on the computer-readable medium 306. The software, when executed by the processor 304, causes the processing system 314 to perform the various functions described below for any particular apparatus. The computer-readable medium 306 and the memory 305 may also be used for storing data that is manipulated by the processor 304 when executing software. In some aspects of the disclosure, the computer-readable medium 306 may include communication instructions 352. The communication instructions 352 may include instructions for performing various operations related to wireless communication (e.g., signal reception and/or signal transmission) as described herein. For example, the communication instructions 352 may include code for configuring the processing system 314 and communication interface 310 to communicate and control a plurality of scheduled entities using sidelink communication. In some aspects of the disclosure, the computer-readable medium 306 may include processing instructions 354. The processing instructions 354 may include instructions for performing various operations related to signal processing (e.g., processing a received signal and/or processing a signal for transmission) as described herein. In one example, the processing instructions 354 include code that may be executed by the processor 304 to control and schedule sidelink communication as described in FIGS. 7-18.

At least one processor 304 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 306 may reside in the processing system 314, external to the processing system 314, or distributed across multiple entities including the processing system 314. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, at least one processor 304 may include a communication circuit 342. The communication circuit 342 may include one or more hardware components that provide the physical structure that performs various processes related to wireless communication (e.g., signal reception and/or signal transmission) as described herein. For example, the communication circuit 340 may be configured to control and schedule sidelink communication among a plurality of scheduled entities. The communication circuit 342 may transmit or broadcast sidelink grants or control information to the scheduled entities using a downlink control channel (e.g., PDCCH) via the communication interface 310. In some aspects of the disclosure, the processor 304 may also include a processing circuit 344. The processing circuit 344 may include one or more hardware components that provide the physical structure that performs various processes related to signal processing (e.g., processing a received signal and/or processing a signal for transmission) as described herein. The circuitry included in the processor 304 is provided as non-limiting examples. Other means for carrying out the described functions exists and is included within various aspects of the present disclosure. In some aspects of the disclosure, the computer-readable medium 306 may store computer-executable code comprising instructions configured to perform various processes described herein. The instructions included in the computer-readable medium 306 are provided as non-limiting examples. Other instructions configured to carry out the described functions exist and are included within various aspects of the present disclosure.

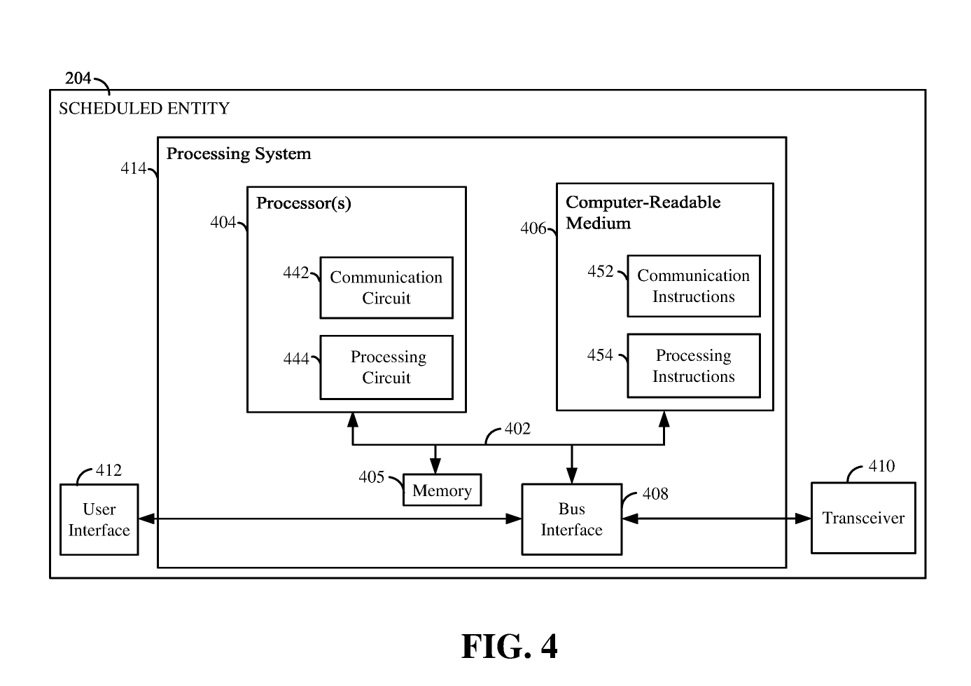

FIG. 4 is a diagram 400 illustrating an example of a hardware implementation for a scheduled entity 204 according to aspects of the present disclosure. The scheduled entity 204 may employ a processing system 414. The scheduled entity 204 may be implemented with a processing system 414 that includes one or more processors 404. For example, the scheduled entity 204 may be a user equipment (UE) as illustrated in any one or more of FIGS. 1 and/or 2.

Examples of processors 404 include microprocessors, microcontrollers, DSPs, FPGAs, PLDs, state machines, gated logic, discrete hardware circuits, and other suitable hardware configured to perform the various functionality described throughout this disclosure. In various examples, scheduled entity 204 may be configured to perform any one or more of the functions described herein. That is, the processor 404, as utilized in scheduled entity 204, may be used or configured to implement any one or more of the processes described herein, for example, in FIGS. 7-18.

In this example, the processing system 414 may be implemented with a bus architecture, represented generally by the bus 402. The bus 402 may include any number of interconnecting buses and bridges depending on the specific application of the processing system 414 and the overall design constraints. The bus 402 communicatively couples together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits. A bus interface 408 provides an interface between the bus 402 and a transceiver 410. The transceiver 410 provides a communication interface or a means for communicating with various other apparatuses over a transmission medium. Depending upon the nature of the apparatus, a user interface 412 (e.g., keypad, display, speaker, microphone, joystick) may also be provided.

At least one processor 404 is responsible for managing the bus 402 and general processing, including the execution of software stored on the computer-readable medium 406. The software, when executed by the processor 404, causes the processing system 414 to perform the various functions described below for any particular apparatus. The computer-readable medium 406 and the memory 405 may also be used for storing data that is manipulated by the processor 404 when executing software. In some aspects of the disclosure, the computer-readable medium 406 may include communication instructions 452. The communication instructions 452 may include instructions for performing various operations related to wireless communication (e.g., signal reception and/or signal transmission) as described herein. In some aspects of the disclosure, the instructions 452 may include code for configuring the scheduled entity to perform sidelink communication as described in relation to FIGS. 7-18. In some aspects of the disclosure, the computer-readable medium 406 may include processing instructions 454. The processing instructions 454 may include instructions for performing various operations related to signal processing (e.g., processing a received signal and/or processing a signal for transmission) as described herein. In some aspects of the disclosure, the processing instructions 454 may include code for configuring the scheduled entity to perform sidelink communication as described in relation to FIGS. 7-18.

At least one processor 404 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a CD or a DVD), a smart card, a flash memory device (e.g., a card, a stick, or a key drive), a RAM, a ROM, a PROM, an EPROM, an EEPROM, a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, at least one processor 404 may include a communication circuit 442. The communication circuit 442 may include one or more hardware components that provide the physical structure that performs various processes related to wireless communication (e.g., signal reception and/or signal transmission) as described herein. For example, the communication circuit 442 may be configured to perform sidelink communication as described in relation to FIGS. 7-18. In some aspects of the disclosure, the processor 404 may also include a processing circuit 444. The processing circuit 444 may include one or more hardware components that provide the physical structure that performs various processes related to signal processing (e.g., processing a received signal and/or processing a signal for transmission) as described herein. For example, the processing circuit 444 may be configured to perform sidelink communication as described in relation to FIGS. 7-18.

The circuitry included in the processor 404 is provided as non-limiting examples. Other means for carrying out the described functions exists and is included within various aspects of the present disclosure. In some aspects of the disclosure, the computer-readable medium 406 may store computer-executable code comprising instructions configured to perform various processes described herein. The instructions included in the computer-readable medium 406 are provided as non-limiting examples. Other instructions configured to carry out the described functions exist and are included within various aspects of the present disclosure.

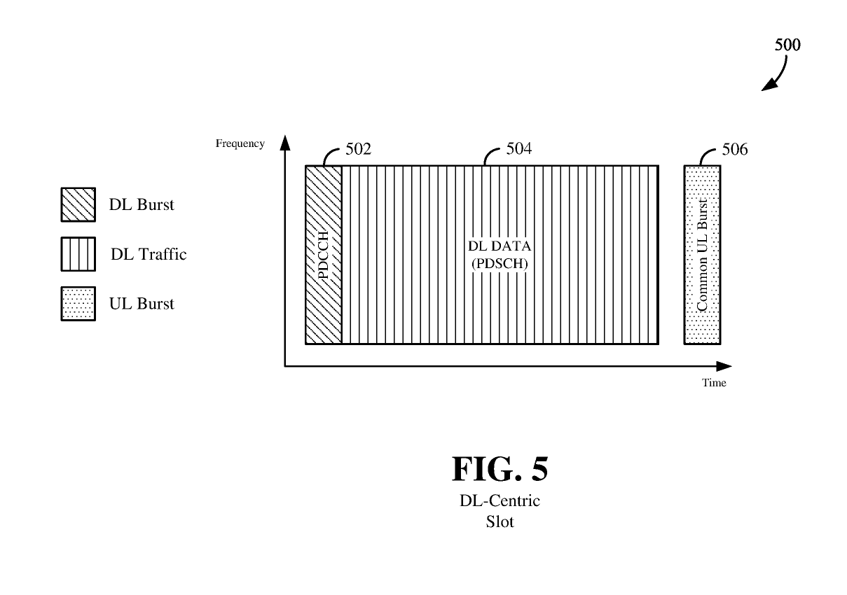

According to various aspects of the disclosure, wireless communication may be implemented by dividing transmissions, in time, into frames, wherein each frame may be further divided into subframes or slots. These subframes or slots may be DL-centric, UL-centric, or sidelink-centric, as described below. For example, FIG. 5 is a diagram illustrating an example of a downlink (DL)-centric slot 500 according to some aspects of the disclosure. The DL-centric slot is referred to as a DL-centric slot because a majority (or, in some examples, a substantial portion) of the slot includes DL data. In the example shown in FIG. 5, time is illustrated along a horizontal axis, while frequency is illustrated along a vertical axis. The time-frequency resources of the DL-centric slot 500 may be divided into a DL burst 502, a DL traffic portion 504 and an UL burst 506.

The DL burst 502 may exist in the initial or beginning portion of the DL-centric slot. The DL burst 502 may include any suitable DL information in one or more channels. In some examples, the DL burst 502 may include various scheduling information and/or control information corresponding to various portions of the DL-centric slot. In some configurations, the DL burst 502 may be a physical DL control channel (PDCCH), as indicated in FIG. 5. Additional description related to the PDCCH is provided further below with reference to various other drawings. The DL-centric slot may also include a DL traffic portion 504. The DL traffic portion 504 may sometimes be referred to as the payload of the DL-centric slot. The DL traffic portion 504 may include the communication resources utilized to communicate DL user data traffic from the scheduling entity 202 (e.g., eNB) to the scheduled entity 204 (e.g., UE). In some configurations, the DL traffic portion 504 may be a physical DL shared channel (PDSCH).

The UL burst 506 may include any suitable UL information in one or more channels. In some examples, the UL burst 506 may include feedback information corresponding to various other portions of the DL-centric slot. For example, the UL burst 506 may include feedback information corresponding to the control portion 502 and/or DL traffic portion 504. Non-limiting examples of feedback information may include an ACK signal, a NACK signal, a HARQ indicator, and/or various other suitable types of information. The UL burst 506 may include additional or alternative information, such as information pertaining to random access channel (RACH) procedures, scheduling requests (SRs), and various other suitable types of information.

As illustrated in FIG. 5, the end of the DL traffic portion 504 may be separated in time from the beginning of the UL burst 506. This time separation may sometimes be referred to as a gap, a guard period, a guard interval, and/or various other suitable terms. This separation provides time for the switch-over from DL communication (e.g., reception operation by the scheduled entity 204 (e.g., UE)) to UL communication (e.g., transmission by the scheduled entity 204 (e.g., UE)). One of ordinary skill in the art will understand that the foregoing is merely one example of a DL-centric slot and alternative structures having similar features may exist without necessarily deviating from the aspects described herein.

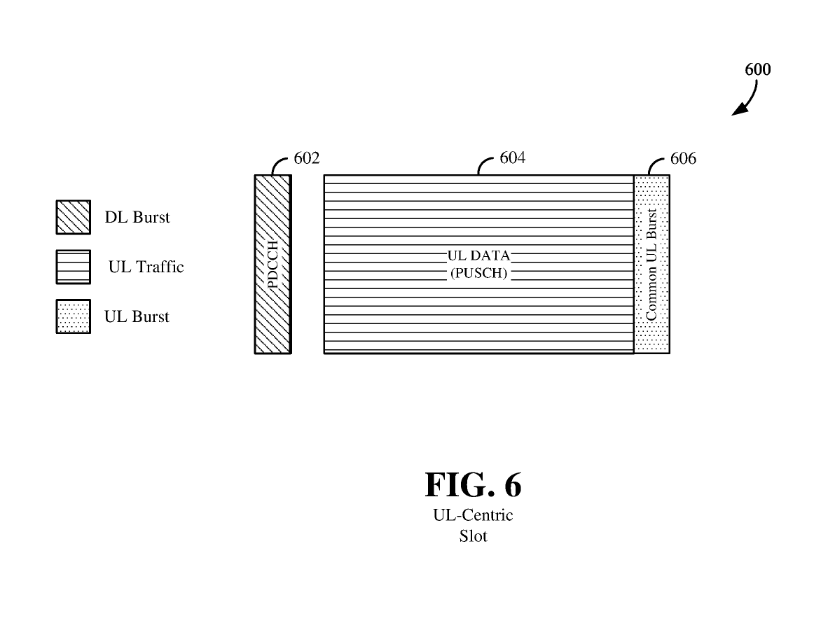

FIG. 6 is a diagram showing an example of an uplink (UL)-centric slot 600 according to some aspects of the disclosure. The UL-centric slot is referred to as a UL-centric slot because a majority (or, in some examples, a substantial portion) of the slot includes UL data. In the example shown in FIG. 6, time is illustrated along a horizontal axis, while frequency is illustrated along a vertical axis. The time-frequency resources of the UL-centric slot 600 may be divided into a DL burst 602, an UL traffic portion 604 and an UL burst 606.

The DL burst 602 may exist in the initial or beginning portion of the UL-centric slot. The DL burst 602 in FIG. 6 may be similar to the DL burst 502 described above with reference to FIG. 5. The UL-centric slot may also include an UL traffic portion 604. The UL traffic portion 604 may sometimes be referred to as the payload of the UL-centric slot. The UL traffic portion 604 may include the communication resources utilized to communicate UL user data traffic from the scheduled entity 204 (e.g., UE) to the scheduling entity 202 (e.g., eNB). In some configurations, the UL traffic portion 604 may be a physical UL shared channel (PUSCH). As illustrated in FIG. 6, the end of the DL burst 602 may be separated in time from the beginning of the UL traffic portion 604. This time, separation may sometimes be referred to as a gap, guard period, guard interval, and/or various other suitable terms. This separation provides time for the switch-over from DL communication (e.g., reception operation by the scheduling entity 202 (e.g., UE)) to UL communication (e.g., transmission by the scheduling entity 202 (e.g., UE)).

The UL burst 606 in FIG. 6 may be similar to the UL burst 506 described above with reference to FIG. 5. The UL burst 606 may additionally or alternatively include information pertaining to channel quality indicator (CQI), sounding reference signals (SRSs), and various other suitable types of information. One of ordinary skill in the art will understand that the foregoing is merely one example of an UL-centric slot, and alternative structures having similar features may exist without necessarily deviating from the aspects described herein.

In some circumstances, two or more scheduled entities 204 (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one scheduled entity 204 (e.g., UE₁) to another scheduled entity 204 (e.g., UE₂) without relaying that communication through the scheduling entity 202 (e.g., eNB), even though the scheduling entity 202 (e.g., eNB) may be utilized for scheduling and/or control purposes. In some examples, the sidelink signals may be communicated using licensed spectrum (unlike wireless local area networks, which typically use an unlicensed spectrum).

However, communication using sidelink signals may increase the relative likelihood of signal interference in certain circumstances. For example, without the aspects described in the present disclosure, interference may occur between the sidelink signals and the DL/UL control/scheduling information of nominal traffic. That is, the DL/UL control/scheduling information of nominal traffic may not be as well protected. As another example, without the aspects described in the present disclosure, interference may occur between sidelink signals originating from different scheduled entities 204 (e.g., UEs). That is, concurrently transmitted sidelink signals may collide and/or interfere with each other. Aspects of the present disclosure provide for an interference management scheme for concurrent sidelink signals and sidelink-centric subframes or slots that enable sidelink interference management.

FIG. 7 is a diagram illustrating an example of a sidelink-centric slot 700 according to some aspects of the present disclosure. In some configurations, this sidelink-centric slot may be utilized for broadcast communication. A broadcast communication may refer to a point-to-multipoint transmission by one scheduled entity 204 (e.g., UE₁) to a set of one or more scheduled entities 204 (e.g., UE₂-UE_{N}). In this example, the sidelink-centric slot includes a DL burst 702, which may include a PDCCH. In some aspects, the DL burst 702 may be similar to the DL burst 502 described in greater detail above with reference to FIG. 5. Additionally or alternatively, the DL burst 702 may include grant information related to the sidelink signal or sidelink communication. Non-limiting examples of grant information may include generic grant information and link-specific grant information. Link-specific grant information may refer to information that enables a specific sidelink communication to occur between two particular scheduled entities 204 (e.g., UEs). In comparison, generic grant information may refer to information that generally enables sidelink communications to occur within a particular cell, without specifying a particular sidelink communication.

Notably, as illustrated in FIG. 7, the DL burst 702 may be included in the beginning or initial portion of the sidelink-centric slot. By including the DL burst 702 in the beginning or initial portion of the sidelink-centric slot, the likelihood of interfering with the DL bursts 502, 602 of DL-centric and UL-centric slots of nominal traffic can be reduced or minimized. In other words, because the DL-centric slot, the UL-centric slot, and the sidelink-centric slot have their DL control information communicated during a common portion of their respective slots, the likelihood of interference between the DL control information and the sidelink signals can be reduced or minimized That is, the DL bursts 502, 602 of DL-centric and UL-centric slots (of nominal traffic) are relatively better protected.

The sidelink-centric slot 700 may also include a source transmit signal (STS) 704 portion (formerly referred to as, or similar to a, request-to-send (RTS) portion). The STS 704 portion may refer to a portion of the slot during which one scheduled entity 204 (e.g., a UE utilizing a sidelink signal) communicates a request signal (i.e., an STS) indicating a requested duration of time to keep a sidelink channel available for a sidelink signal. One of ordinary skill in the art will understand that the STS may include various additional or alternative information without necessarily deviating from the scope of the present disclosure. In some configurations, the STS may include a group destination identifier (ID). The group destination ID may correspond to a group of devices that are intended to receive the STS. In some configurations, the STS may indicate a duration of the sidelink transmission, and/or may include a reference signal to enable channel estimation and RX-yielding (described below), a modulation and coding scheme (MCS) indicator, and/or various other information. In some examples, the STS reference signal may be transmitted at a higher (e.g., boosted) power level to provide additional protection of the broadcast. Further, the STS MCS indicator may be utilized to inform the receiving device of the MCS utilized for transmissions in the sidelink data portion 706. Here, the reference signal may take any suitable form or structure on the channel that may be useful for interference management (e.g., by creating a predictable amount of interference) and channel management at the receiver. In some configurations, the STS (or, in other examples, the DRS) may include a release flag, configured to explicitly signal that the transmitting device is releasing sidelink resources that may have previously been requested by the transmitting device, or in other words, sending an explicit release signal to indicate that a sidelink device is releasing a sidelink resource. Therefore, the release flag may be set in explicit sidelink signaling (e.g., STS/DRS) to indicate that a sidelink device is releasing a sidelink resource so that other users, which may have been backing off, can get back into trying to access or use the sidelink resources that were previously unavailable.

For the sake of completeness, the following information is provided regarding RX-yielding. Assume that two sidelinks exist. Sidelink₁ is between UE_{A} and UE_{B}, and Sidelink₂ is between UE_{C} and UE_{D}. Assume also that Sidelink₁ has a higher priority than Sidelink₂. If UE_{A} and UE_{C} concurrently transmit STS, UE_{D} will refrain from transmitting a DRS, because Sidelink₁ has a higher priority than Sidelink₂. Accordingly, the relatively lower priority sidelink (Sidelink₂) yields communication of the DRS under these circumstances.

A first scheduled entity 204 (e.g., UE₁) may transmit an STS to one or more other scheduled entities 204 (e.g., UE₂, UE₃) to request that the other scheduled entities 204 (e.g., UE₂, UE₃) refrain from using the sidelink channel for the requested duration of time, thereby leaving the sidelink channel available for first scheduled entity 204 (e.g., UE₁). By transmitting the STS, the first scheduled entity 204 (e.g., UE₁) can effectively reserve the sidelink channel for a sidelink signal. This enables distributed scheduling and management of interference that might otherwise occur from another sidelink communication from other scheduled entities 204 (e.g., UE₂, UE₃). Put another way, because the other scheduled entities 204 (e.g., UE₂, UE₃) are informed that the first scheduled entity 204 (e.g., UE₁) will be transmitting for the requested period of time, the likelihood of interference between sidelink signals is reduced.

The sidelink-centric slot 700 may also include a sidelink traffic portion 706. The sidelink traffic portion 706 may sometimes be referred to as the payload or sidelink-burst of the sidelink-centric slot. In an example where the sidelink-centric slot is utilized for broadcast communications, the sidelink traffic portion 706 may carry a physical sidelink broadcast channel (PSBCH) (formerly a physical sidelink shared channel (PSSCH)), as indicated in FIG. 7. The sidelink traffic portion 706 may include the communication resources utilized to communicate sidelink user data traffic from one scheduled entity 204 (e.g., UE₁) to one or more other scheduled entities 204 (e.g., UE₂, UE₃).

According to a further aspect of the disclosure, a broadcast sidelink-centric slot may take on certain characteristics based on whether or not the broadcast is separated from other sidelink devices that utilize unicast sidelink-centric slots as described above. Here, a broadcast sidelink-centric slot utilized in the absence of unicast sidelink-centric slot transmissions may be referred to as an orthogonalized broadcast, while a broadcast sidelink-centric slot utilized in the presence of unicast sidelink-centric slot transmissions may be referred to as an in-band broadcast.

The sidelink traffic portion 706 may be configured utilizing a suitable MCS selected according to channel conditions. In one example, the receiving device may select an MCS based on a measurement of a receive power of a reference signal in the STS 704 portion, and a measurement of interference. For example, in low receive power and/or high interference scenarios, the receiving device may select a more robust MCS, e.g., utilizing a lower modulation order and/or a lower coding rate.

The sidelink-centric slot 700 may also include an UL burst 708. In some aspects, the UL burst 708 may be similar to the UL burst 506, 606 described above with reference to FIGS. 5-6. Notably, as illustrated in FIG. 7, the UL burst 708 may be included in the end portion of the sidelink-centric slot 700. By including the UL burst 708 in the end portion of the sidelink-centric slot, the likelihood of interfering with the UL bursts 506, 606 of DL-centric and UL-centric slots of nominal traffic is minimized or reduced. In other words, because the DL-centric slot, the UL-centric slot, and the sidelink-centric slot have their UL bursts 506, 606, 708 communicated during a similar portion of their respective slot, the likelihood of interference between those UL bursts 506, 606, 708 is minimized or reduced. That is, the UL bursts 506, 606 of DL-centric and UL-centric slots (of nominal traffic) are relatively better protected.

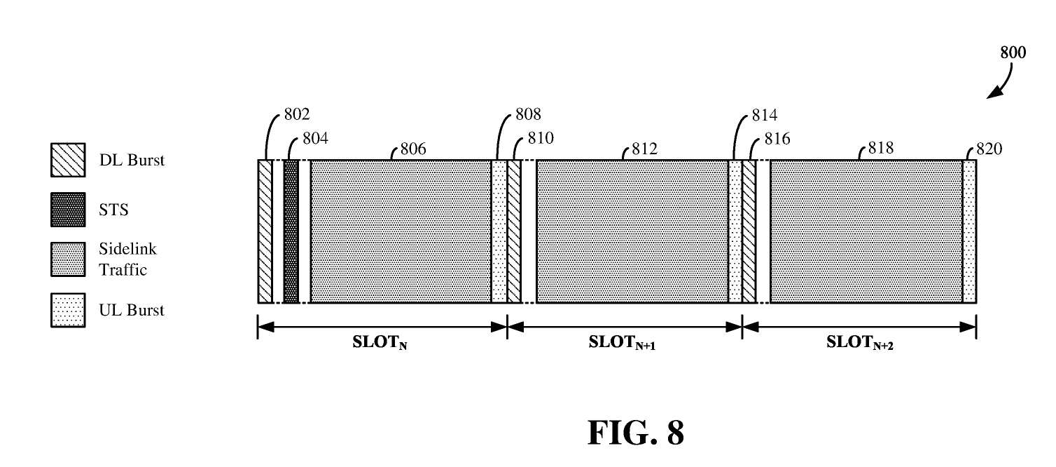

FIG. 8 is a diagram illustrating an example of multiple concurrent sidelink-centric slots 800 according to some aspects of the present disclosure. In some configurations, the sidelink-centric slots may be utilized for broadcast communication. Although the example illustrated in FIG. 8 shows three slots (e.g., SLOT_{N}, SLOT_{N+1}, SLOT_{N+2}), one of ordinary skill in the art will understand that any plural number of slots may be included without deviating from the scope of the present disclosure. The first slot (e.g., SLOT_{N}) may include a DL burst 802 (e.g., PDCCH, as described in greater detail above) and an STS portion 804 (as also described in greater detail above). The STS portion 804 may indicate a duration that extends across more than one slot (e.g., SLOT_{N}, SLOT_{N+1}, SLOT_{N+2}). In other words, the STS may indicate a requested duration of time to keep the sidelink channel available for sidelink signals, and that requested duration may extend until the end of the last slot (e.g., SLOT_{N+2}) of a plurality of slots (e.g., SLOT_{N}, SLOT_{N+1}, SLOT_{N+2}). Therefore, although the plurality of slots (e.g., SLOT_{N}, SLOT_{N+1}, SLOT_{N+2}) each include a sidelink traffic portion 806, 812, 818, not every slot requires the STS portion 804. By not including the STS portion 804 in every slot of the plurality of slots (e.g., SLOT_{N}, SLOT_{N+1}, SLOT_{N+2}), the overall amount of overhead is relatively lower than it would otherwise be (e.g., if the STS portion 804 was included in every slot). By reducing overhead, relatively more of the slots (e.g., SLOT_{N+1}, SLOT_{N+2}) lacking the STS portion 804 can be utilized for communication of the sidelink traffic portion 812, 818, which thereby increases relative throughput.

Within the first slot (e.g., SLOT_{N}), the STS portion 804 may be followed by a sidelink traffic portion 806 (which is described in greater detail above with reference to the sidelink traffic portion 706 in FIG. 7). The sidelink traffic portion 806 may be followed by the UL burst 808 (which is described in greater detail above with reference to the UL burst 708 in FIG. 7). In the example illustrated in FIG. 8, every slot (e.g., SLOT_{N+1}, SLOT_{N+2}) following the first slot (e.g., SLOT_{N}) includes a DL burst 810, 816 at an initial/beginning portion of each slot and an UL burst 814, 820 at the end portion of each slot. By providing the DL burst 810, 816 at the initial/beginning of each slot and providing the UL burst 814, 820 at the end portion of each slot, the sidelink-centric slots have a structure that minimizes the likelihood of interference with DL/UL control/scheduling information of nominal traffic (as described in greater detail above).

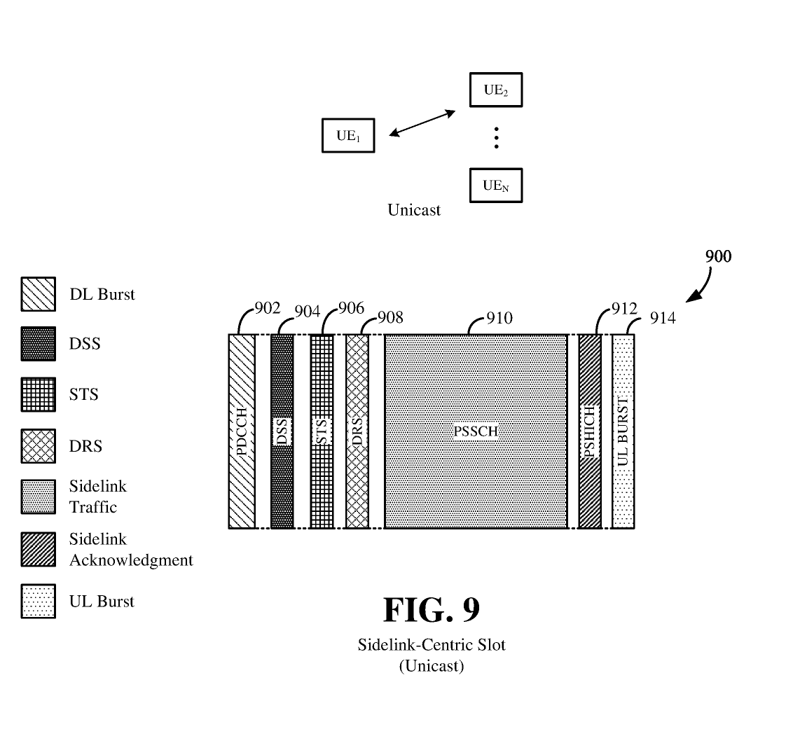

FIG. 9 is a diagram illustrating another example of a sidelink-centric slot 900 according to some aspects of the present disclosure. In some configurations, this sidelink-centric slot, or a slot having similar structure, may be utilized for a unicast communication. A unicast communication may refer to a point-to-point transmission by a scheduled entity 204 (e.g., UE₁) to a particular scheduled entity 204 (e.g., UE₂).

In each of the sidelink-centric slots that follow, as described below, for a given device, certain fields or portions of the slot may correspond to transmissions from that device or reception at that device, depending on whether that given device is transmitting sidelink traffic or receiving sidelink traffic. As illustrated in each of FIGS. 9-13, a time gap (e.g., guard interval, guard period, etc.) Between adjacent data portions, if any, may enable a device to transition from a listening/receiving state (e.g., during DSS 904 for a non-primary device) to a transmitting state (e.g., during STS 906 for a non-primary device); and/or to transition from a transmitting state (e.g., during STS 906 for a non-primary device) to a listening/receiving state (e.g., during DRS 908 for either a primary or non-primary transmitting device). The duration of such a time gap or guard interval may take any suitable value, and it should be understood that the illustrations in FIGS. 9-14 are not to scale with respect to time. Many such time gaps are shown in the various illustrations to represent some aspects of particular embodiments, but it should be understood that the illustrated time gaps may be wider or narrower than they appear, and in some examples, an illustrated time gap may not be utilized, while in other examples, the lack of a time gap might be replaced with a suitable time gap between regions of a slot. In some aspects of the disclosure, a particular slot may be structured with time gaps corresponding to TX-RX transitions as well as RX-TX transitions, in order that the same slot structure may accommodate the operation of a given device both when that device is transmitting sidelink traffic, and when that device is receiving sidelink traffic.

In the example illustrated in FIG. 9, the sidelink-centric slot includes a DL burst 902, which may include a physical downlink control channel (PDCCH). In some aspects, the DL burst 902 may be configured the same as or similar to the DL burst 502 (e.g., PDCCH) described in greater detail above with reference to FIG. 5. Additionally or alternatively, the DL burst 902 may include grant information related to the sidelink signal or sidelink communication. Non-limiting examples of grant information may include generic grant information and link-specific grant information. Link-specific grant information may refer to information that enables a specific sidelink communication to occur between two particular scheduled entities 204 (e.g., UEs). In comparison, generic grant information may refer to information that generally enables sidelink communications to occur within a particular cell, without specifying a particular sidelink communication.

Notably, as illustrated in FIG. 9, the DL burst 902 may be included in the beginning or initial portion of the sidelink-centric slot 900. By including the DL burst 902 in the beginning or initial portion of the sidelink-centric slot 900, the likelihood of interfering with the DL bursts 502, 602 of DL-centric and UL-centric slots of nominal traffic is minimized In other words, because the DL-centric slot 500, the UL-centric slot 600, and the sidelink-centric slot 900 have their DL control information communicated during a common portion of their respective slots, the likelihood of interference between the DL control information and the sidelink signals is minimized That is, the DL bursts 502, 602 of DL-centric and UL-centric slots (of nominal traffic) are relatively better protected.

The sidelink-centric slot 900 may further include a primary request signal such as a direction selection signal (DSS) 904, and a secondary request signal such as a source transmit signal (STS) 906. In various examples, the content of the DSS and the STS may take different formats. As one example, the DSS 904 may be utilized for direction selection and the STS 906 may be utilized as a request signal. Here, direction selection refers to the selection whether a primary sidelink device transmits a request signal in the STS, or whether a primary sidelink device receives a request signal (i.e., a non-primary or secondary sidelink device transmits a request signal in the STS). In this example, the DSS may include a destination ID (e.g., corresponding to a non-primary or secondary sidelink device) and a direction indication. In this manner, a listening sidelink device that receives the DSS transmission and is not the device corresponding to the destination ID need not necessarily be active and monitoring for the STS transmission. In this example, the STS may include an indication of a requested duration of time to reserve a sidelink channel for sidelink data. Accordingly, with the STS/DSS portions of the sidelink-centric slot 900, a request for reservation of the sidelink channel in a desired direction between a primary and a non-primary sidelink device may be established.

In another example, content of the DSS 904 and the STS 906 may be substantially similar to one another, although the DSS 904 may be utilized by a primary sidelink device and the STS 906 may be utilized by a secondary sidelink device. The DSS and/or STS may be utilized by a scheduled entity 204 (e.g., UE) as a request signal to indicate a requested duration of time to keep a sidelink channel available for a sidelink signal. One of ordinary skill in the art will understand that the DSS and/or STS may include various additional or alternative information without necessarily deviating from the scope of the present disclosure. In some configurations, the DSS and/or STS may include a destination identifier (ID). The destination ID may correspond to a specific apparatus intended to receive the STS/DSS (e.g., UE2). In some configurations, the DSS and/or STS may indicate a duration of the sidelink transmission, and/or may include a reference signal to enable channel estimation and RX-yielding, a modulation and coding scheme (MCS) indicator, and/or various other information. Here, the MCS indicator may be utilized to inform the receiving device of the MCS utilized for transmissions in the sidelink traffic portion.

A primary device may transmit a primary request signal (e.g., a DSS) during a primary request portion of a slot (e.g., DSS 904), and a non-primary device (e.g., a secondary device) may transmit a secondary request signal (e.g., an STS) during a secondary request portion of the slot (e.g., STS 906 portion). A primary device may refer to a device (e.g., a UE or scheduled entity 204) that has priority access to the sidelink channel During an association phase, one device may be selected as the primary device and another device may be selected as the non-primary (e.g., secondary) device. In some configurations, the primary device may be a relay device that relays a signal from a non-relay device to another device, such as a scheduling entity 202 (e.g., base station). The relay device may experience relatively less path loss (when communicating with the scheduling entity 202 (e.g., base station)) relative to the path loss experienced by the non-relay device.

During the DSS 904 portion, the primary device transmits a DSS, and the non-primary device listens for the DSS from a primary device. On the one hand, if the non-primary device detects a DSS during the DSS 904 portion, then the non-primary device will not transmit an STS during the STS 906 portion. On the other hand, if the non-primary device does not detect a DSS during the DSS 904 portion, then the non-primary device may transmit an STS during the STS 906 portion.

If the sidelink channel is available for the requested duration of time, an apparatus identified or addressed by the destination ID in the STS/DSS, which receives the STS/DSS, may communicate a confirmation signal, such as a destination receive signal (DRS), during the DRS 908 portion. The DRS may indicate availability of the sidelink channel for the requested duration of time. The DRS may additionally or alternatively include other information, such as a source ID, a duration of the transmission, a signal to interference plus noise ratio (SINR) (e.g., of the received reference signal from the source device), a reference signal to enable TX-yielding, CQI information, and/or various other suitable types of information. The exchange of STS/DSS and DRS enable the scheduled entities 204 (e.g., UEs) performing the sidelink communications to negotiate the availability of the sidelink channel prior to the communication of the sidelink signal, thereby minimizing the likelihood of interfering sidelink signals. In other words, without the STS/DSS and DRS, two or more scheduled entities 204 (e.g., UEs) might concurrently transmit sidelink signals using the same resources of the sidelink traffic portion 910, thereby causing a collision and resulting in avoidable retransmissions.

The sidelink-centric slot may also include a sidelink traffic portion 910. The sidelink traffic portion 910 may sometimes be referred to as the payload or sidelink-burst of the sidelink-centric slot. In an example where the sidelink-centric slot is utilized for unicast transmissions, the sidelink traffic portion 910 may carry a physical sidelink shared channel (PSSCH). The sidelink traffic portion 910 may include the communication resources utilized to communicate sidelink user data traffic from one scheduled entity 204 (e.g., UE₁) to a second scheduled entity 204 (e.g., UE₂). In some configurations, the MCS of the sidelink signal communicated in the sidelink traffic portion 910 may be selected based on the CQI feedback included in the DRS 908.

The sidelink-centric slot may also include a sidelink acknowledgment portion 912. In some aspects, the sidelink acknowledgment portion 912 may carry a physical sidelink HARQ indicator channel (PSHICH). After communicating the sidelink signal in the sidelink traffic portion 910, acknowledgment information may be communicated between the scheduled entities 204 (e.g., UEs) utilizing the sidelink acknowledgment portion 912. Non-limiting examples of such acknowledgment information may include an ACK signal, a NACK signal, a HARQ indicator, and/or various other suitable types of acknowledgment information. For example, after receiving and successfully decoding a sidelink signal from UE₁ in the sidelink traffic portion 910, UE₂ may transmit an ACK signal to the UE₁ in the sidelink acknowledgment portion 912 of the sidelink-centric slot.

The sidelink-centric slot may also include an UL burst 914. In some aspects, the UL burst 914 may be configured the same as or similar to the UL burst 506, 606 described above with reference to FIGS. 5-6. Notably, as illustrated in the example of FIG. 9, the UL burst 914 may be included in the end portion of the sidelink-centric slot. By including the UL burst 914 in the end portion of the sidelink-centric slot, the likelihood of interfering with the UL burst 506, 606 of DL-centric and UL-centric slots of nominal traffic is minimized In other words, because the DL-centric slot, the UL-centric slot, and the sidelink-centric slot have their UL burst 506, 606, 914 communicated during the same or similar portion of their respective slot, the likelihood of interference between those UL bursts 506, 606, 914 is reduced. That is, the UL bursts 506, 606 of DL-centric and UL-centric slots (of nominal traffic) are relatively better protected.

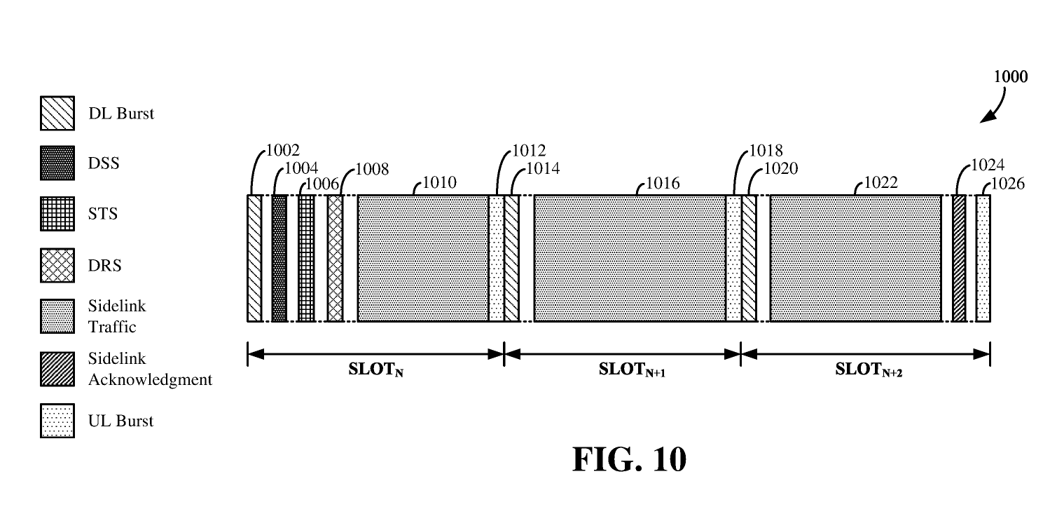

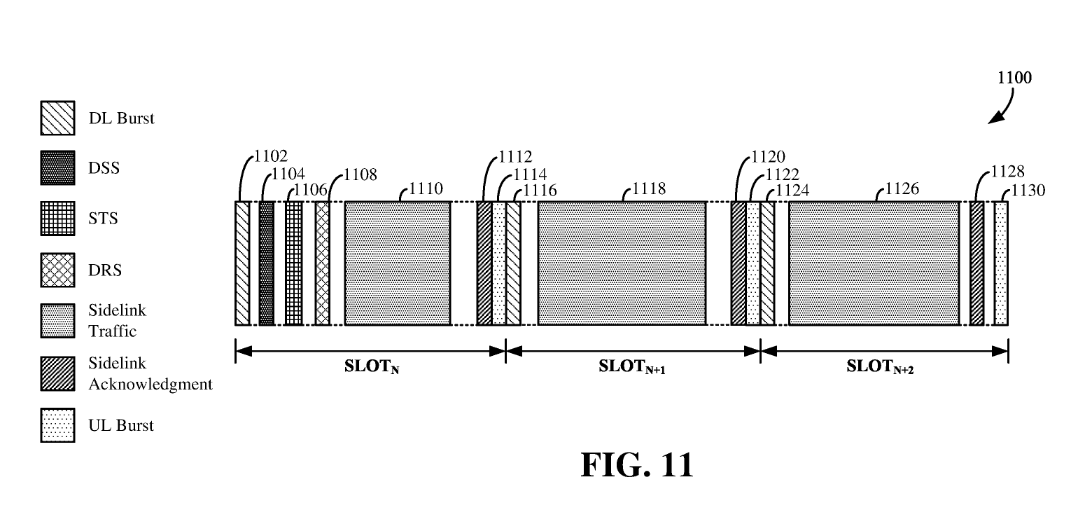

FIGS. 10-11, described below, illustrate multiple concurrent sidelink-centric slots according to some aspects of the disclosure. As with the example described above in relation to FIG. 9, in some configurations, the concurrent sidelink-centric slots in FIGS. 10 and 11 may be utilized for unicast communication. Although the examples illustrated in FIGS. 10 and 11 show three slots (e.g., SLOT_{N}, SLOT_{N+1}, SLOT_{N+2}), one of ordinary skill in the art will understand that any plural number of concurrent sidelink-centric slots may be included as described herein without deviating from the scope of the present disclosure.

Referring now specifically to FIG. 10, a diagram illustrates an example of multiple concurrent sidelink-centric slots 1000 according to an aspect of the present disclosure. The first slot (e.g., SLOT_{N}) may include the DL burst 1002 (e.g., PDCCH, as described in greater detail above), DSS 1004, STS 1006, and DRS 1008 (as also described in greater detail above). In this example, the request signal communicated during DSS 1004 and/or STS 1006 may indicate a duration that extends across the plurality of slots (e.g., SLOT_{N}, SLOT_{N+1}, SLOT_{N+2}). In other words, the request signal may indicate a requested duration of time to keep the sidelink channel available for sidelink signals, and that requested duration may extend until the end of the last slot (e.g., SLOT_{N+2}) of the plurality of slots (e.g., SLOT_{N}, SLOT_{N+1}, SLOT_{N+2}). If the sidelink channel is available for that requested duration of time, then the confirmation signal (e.g., DRS) may be communicated in the DRS 1008 portion (as described in greater detail above).

Although the plurality of slots (e.g., SLOT_{N}, SLOT_{N+1}, SLOT_{N+2}) each include a sidelink traffic portion 1010, 1016, 1022, not every slot necessarily requires DSS 1004 and/or STS 1006. By not including DSS 1004 and/or STS 1006 in every slot of the plurality of slots (e.g., SLOT_{N}, SLOT_{N+1}, SLOT_{N+2}), the overall amount of overhead is relatively lower than it would otherwise be (e.g., if DSS 1004 and/or STS 1006 were included in every slot). By reducing overhead, relatively more of the slots (e.g., SLOT_{N+1}, SLOT_{N+2}) lacking DSS 1004 and/or STS 1006 can be utilized for communication of the sidelink traffic 1016, 1022, which thereby increases relative throughput.

Within the first slot (e.g., SLOT_{N}), DSS 1004, STS 1006, and DRS 1008 may be followed by a first sidelink traffic portion 1010 (which is described in greater detail above with reference to the sidelink traffic portion 910 in FIG. 9). The sidelink traffic portions 1010, 1016, and 1022 may each be followed by respective UL bursts 1012, 1018, and 1026 (which are described in greater detail above with reference to the UL burst 914 in FIG. 9). In the example illustrated in FIG. 10, every slot (e.g., SLOT_{N+1}, SLOT_{N+2}) following the first slot (e.g., SLOT_{N}) includes a DL burst 1014, 1020 at an initial/beginning portion of each slot and an UL burst 1018, 1026 at the end portion of each slot. By providing the DL burst 1014, 1020 at the initial/beginning of each slot and providing the UL burst 1018, 1026 at the end portion of each slot, the sidelink-centric slots have a structure that minimizes the likelihood of interference with DL/UL control/scheduling information of nominal traffic (as described in greater detail above).

In the example illustrated in FIG. 10, the sidelink-centric slots 1000 include a single sidelink acknowledgment portion 1024 in a last/final slot (e.g., SLOT_{N+2}) of the plurality of slots (e.g., SLOT_{N}, SLOT_{N+1}, SLOT_{N+2}). The acknowledgment information communicated in the sidelink acknowledgment portion 1024 in the last/final slot (e.g., SLOT_{N+2}) may correspond to the sidelink signals included in one or more (e.g., all) preceding sidelink traffic portions 1010, 1016, 1022. For example, the sidelink acknowledgment portion 1024 may include a HARQ identifier corresponding to sidelink signals communicated throughout the sidelink traffic portions 1010, 1016, 1022 of the plurality of slots (e.g., SLOT_{N}, SLOT_{N+1}, SLOT_{N+2}). Because the sidelink acknowledgment portion 1024 is not included in every slot (e.g., SLOT_{N}, SLOT_{N+1}), the overall amount of overhead is relatively lower than it would otherwise be (e.g., if a sidelink acknowledgment portion were included in every slot). By reducing overhead, relatively more of the slots (e.g., SLOT_{N}, SLOT_{N+1}) lacking the sidelink acknowledgment portion 1024 can be utilized for communication of sidelink user data traffic, which thereby increases relative throughput. However, one of ordinary skill in the art will readily understand that the example illustrated in FIG. 10 is non-limiting and alternative configurations may exist without necessarily deviating from the scope of the present disclosure.

FIG. 11 is a diagram illustrating one example of such an alternative configuration of multiple concurrent sidelink-centric slots 1100. Various aspects illustrated in FIG. 11 (e.g., DL bursts 1102, 1116, 1124; DSS 1104; STS 1106; DRS 1108; and UL bursts 1114, 1122, 1130) are described above with reference to FIG. 7 and therefore will not be repeated here to avoid redundancy. An aspect in which the example illustrated in FIG. 11 may differ from the example illustrated in FIG. 10 is that the example in FIG. 11 includes a sidelink acknowledgment portion 1112, 1120, 1128 in every slot of the plurality of slots (e.g., SLOT_{N}, SLOT_{N+1}, SLOT_{N+2}). For example, each sidelink acknowledgment portion 1112, 1120, and 1128 may respectively communicate acknowledgment information corresponding to a sidelink signal included in the sidelink traffic portion 1110, 1118, and 1126 in its slot. By receiving acknowledgment information corresponding to the sidelink signal in that particular slot, the scheduled entity 204 (e.g., UE) may obtain relatively better specificity regarding the communication success of each sidelink signal. For example, if only one sidelink signal in a single sidelink traffic portion (e.g., sidelink traffic portion 1110) is not successfully communicated, retransmission can be limited to only the affected sidelink traffic portion (e.g., sidelink traffic portion 1110) without the burden of retransmitting unaffected sidelink traffic portions (e.g., other sidelink traffic portions 1118, 1126).

In next-generation (e.g., 5G) networks, the slot duration may be shorter to support lower latency. However, the STS and DRS within the sidelink-centric slot 900 shown in FIG. 9 and/or the sidelink-centric slots shown in FIGS. 10 and 11 may contribute significant overhead, which may increase the duration of the sidelink-centric slot beyond that which 5G networks support.

Therefore, in accordance with various aspects of the disclosure, the STS and/or DRS overhead may be reduced using a single-tone signal instead of a multiple-tone signal. As used herein, the term “single-tone signal” refers to a signal generated without digital coding, while the term “multiple-tone signal” refers to a signal generated using digital coding. In addition, as used herein, the term “single-tone signal” refers to a signal that achieves signaling of information through tone identifiers (IDs) (e.g., specific frequencies) and/or signal power levels. For example, single-tone signaling of the STS and/or DRS over the sidelink may utilize tone IDs negotiated between the transmitting and receiving sidelink devices and/or transmit power levels to convey STS and/or DRS information.

In some examples, a single-tone signal may include an analog signal. As used herein, the term “analog signaling” or “analog signal” refers to analog modulation (e.g., amplitude modulation (AM), frequency modulation (FM), phase modulation (PM), double sideband AM, single sideband AM, etc.) of a carrier signal at a transmitting device to transmit information from the transmitting device to a receiving device over the sidelink. However, the term “single-tone signal” is not limited to analog signals, and may include any suitable signal generated without digital coding that utilizes tone identifiers and/or power levels to convey information. In some examples, a multiple-tone signal may include a digital signal. As used herein, the term “digital signaling” or “digital signal” refers to digital modulation (e.g., BPSK, QPSK, QAM, etc.) of a carrier signal at a transmitting device to transmit information from the transmitting device to a receiving device over the sidelink. However, the term “multiple-tone signal” is not limited to digital signals, and may include any suitable digitally coded signal.

In some instances, single-tone signaling may not provide adequate reliable signaling. For example, the DRS may require multiple-tone signaling to adequately transmit the CQI. Therefore, various aspects of the disclosure may further provide for a combination of single-tone and multiple-tone signaling in the STS and DRS portions of a sidelink slot.

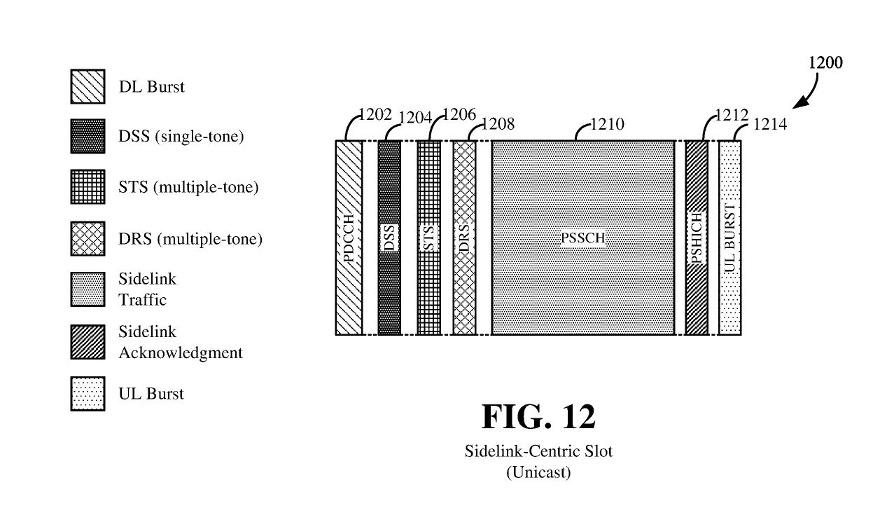

FIG. 12 is a diagram illustrating one example of a configuration of a sidelink-centric slot 1200 utilizing a combination of single-tone and multiple-tone signaling. Various aspects illustrated in FIG. 12 (e.g., DL burst 1202, sidelink traffic portion 1210, sidelink acknowledgment portion 1212 and UL burst 1214) are described above with reference to FIG. 9 and therefore will not be repeated here to avoid redundancy.

In the example shown in FIG. 12, the primary request signal (e.g., the DSS 1204) may be a single-tone signal, while the secondary request signal (e.g., STS 1206) and the confirmation signal (e.g., DRS 1208) may be multiple-tone signals. As described above, the DSS 1204 is utilized to indicate link direction of the sidelink traffic portion 1210 (e.g., from the primary device to the secondary device when the primary device transmits the DSS 1204). Therefore, the DSS 1204 may easily be implemented using single-tone signaling.

To provide sufficient reliability for the STS 1206, which may carry the destination ID, transmission duration and other information (e.g., reference signal, MCS indicator, etc.), the STS 1206 may be a multiple-tone (e.g., digital) signal. Similarly, the DRS 1208 may be a multiple-tone (e.g., digital) signal to provide sufficient reliability for channel state information (e.g., CQI), along with other information, such as the source ID, the duration of the transmission, SINR, the reference signal to enable TX-yielding, ,and/or various other suitable types of information.

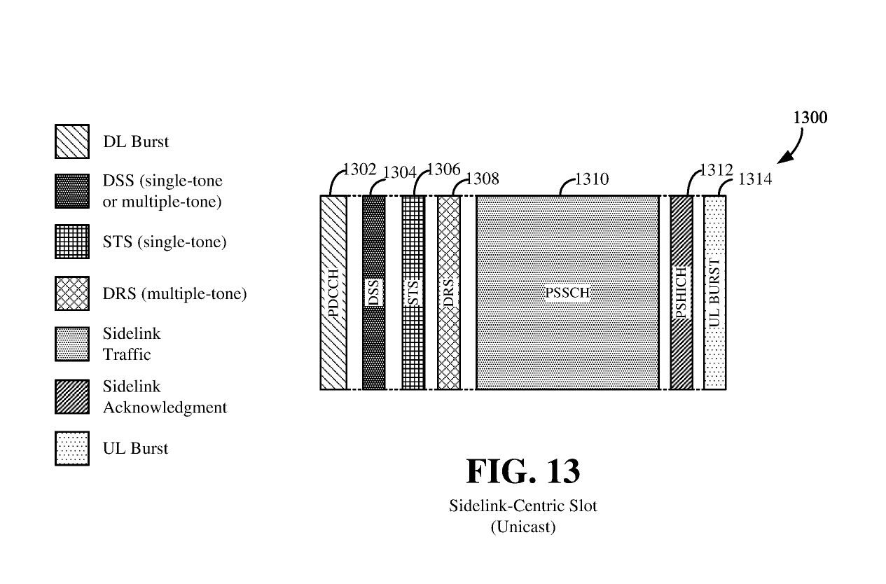

FIG. 13 is a diagram illustrating another example of a configuration of a sidelink-centric slot 1300 utilizing a combination of single-tone and multiple-tone signaling. Various aspects illustrated in FIG. 13 (e.g., DL burst 1302, sidelink traffic portion 1310, sidelink acknowledgment portion 1312 and UL burst 1314) are described above with reference to FIG. 9 and therefore will not be repeated here to avoid redundancy.

In the example shown in FIG. 13, the secondary request signal (e.g., STS 1306) is a single-tone signal, while the confirmation signal (e.g., DRS 1308) is a multiple-tone signal. In this example, the primary request signal (e.g., DSS 1304) may be either a single-tone signal or a multiple-tone signal. In some examples, the DSS 1304 may be a multiple-tone signal to include a reference signal that enables channel estimation at the receiving device.

To significantly reduce overhead, both the primary request signal (e.g., DSS 1304) and the secondary request signal (e.g., STS 1306) may be single-tone signals, while the confirmation signal (e.g., DRS 1308) may be a multiple-tone signal. In this example, the destination ID may include a tone ID (e.g., frequency) negotiated between the primary device and the secondary device upon establishment of the sidelink. For example, a peer discovery mechanism may be used by an initiating device to discover the presence of other devices in a neighborhood or area (e.g., within a radial distance from the location of the initiating device). Once another device of interest is discovered, the initiating device may page the device of interest to associate with the other device and establish a sidelink between the two devices. As part of the association, respective tone IDs may be selected for each device to enable single-tone signaling therebetween. In some examples, the tone IDs may be selected by the initiating device or primary device. In other examples, the tone IDs may be negotiated between the devices. The tone ID of the transmitting device may further be utilized to generate and transmit the DSS 1304.

In some examples, to further minimize the overhead of the STS 1306, the duration of sidelink transmissions may be fixed between the primary and secondary device. Therefore, the single-tone STS 1306 may not need to include a separate requested duration of time. Instead, the requested duration of time may be known to the receiving device, such that upon receiving the single-tone STS 1306, the receiving device has a-priori knowledge of the associated requested duration of time. The fixed duration of time may be selected during the association stage or may be provided to the devices by the network (e.g., scheduling entity). For example, the fixed duration of time associated with the single-tone STS 1306 may be included within the PDCCH 1302 or another control message transmitted by the scheduling entity.

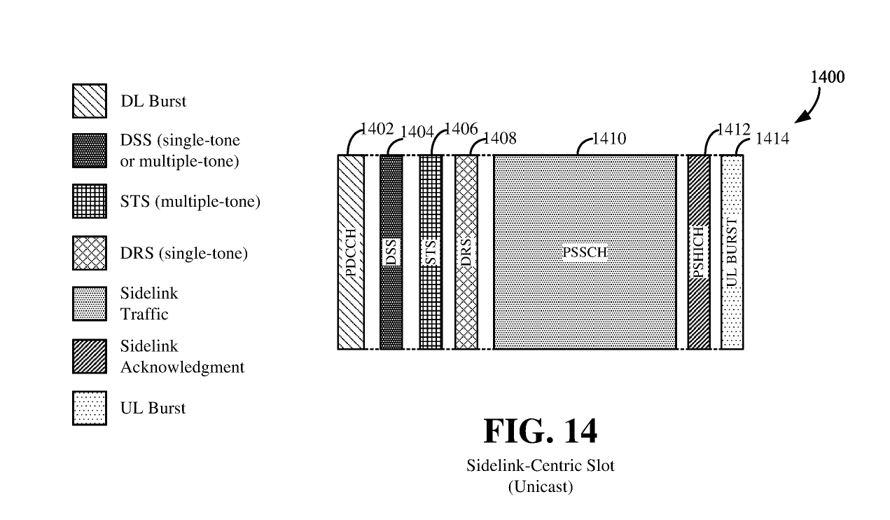

FIG. 14 is a diagram illustrating another example of a configuration of a sidelink-centric slot 1400 utilizing a combination of single-tone and multiple-tone signaling. Various aspects illustrated in FIG. 14 (e.g., DL burst 1402, sidelink traffic portion 1410, acknowledgment portion 1412 and UL burst 1414) are described above with reference to FIG. 9 and therefore will not be repeated here to avoid redundancy.

In the example shown in FIG. 14, the secondary request signal (e.g., STS 1406) is a multiple-tone signal to enable reliable transmission of the destination ID and/or duration information, while the confirmation signal (e.g., DRS 1408) is a single-tone signal. In this example, the primary request signal (e.g., DSS 1404) may be either a single-tone signal or a multiple-tone signal. In some examples, the sidelink signal transmit power and MCS may be fixed between the devices, thus obviating the need for CQI in the DRS 1408. The fixed transmit power and MCS may be selected during the association stage or may be provided to the devices by the network (e.g., scheduling entity). Utilizing a fixed transmit power and MCS may still provide sufficient reliability of the sidelink signal in some scenarios, such as low-payload scenarios (e.g., IoE).

In various aspects of the disclosure, the transmit power of the single-tone DRS 1408 may be selected to control dimensions of a protection zone around the receiving device, thus managing interference for the sidelink signal. As used herein, the term “protection zone” is defined as an area within which the DRS 1408 may be received by other devices. Since the DRS 1408 enables Tx-yielding, any other devices within the protection zone that receive the DRS 1408 and have a lower priority may refrain from transmitting potentially interfering sidelink signals for the indicated duration of time. Thus, the single-tone DRS 1408 may essentially operate as a power backoff instruction to other devices. In some examples, the receiving device may increase the transmit power of the DRS 1408 to increase the protection zone and reduce interference.

Although the controllable DRS transmit power for interference management is described above in connection with a single-tone DRS 1408, it should be understood that the DRS power setting may also be controllable in multiple-tone implementations of the STS and DRS to facilitate power backoff and interference management. In addition to power backoff, such a multiple-tone DRS 1408 may also include other link interference management information, such as the measured SINR of the link, channel quality information, and a reference signal to support Tx-yielding, as described above.

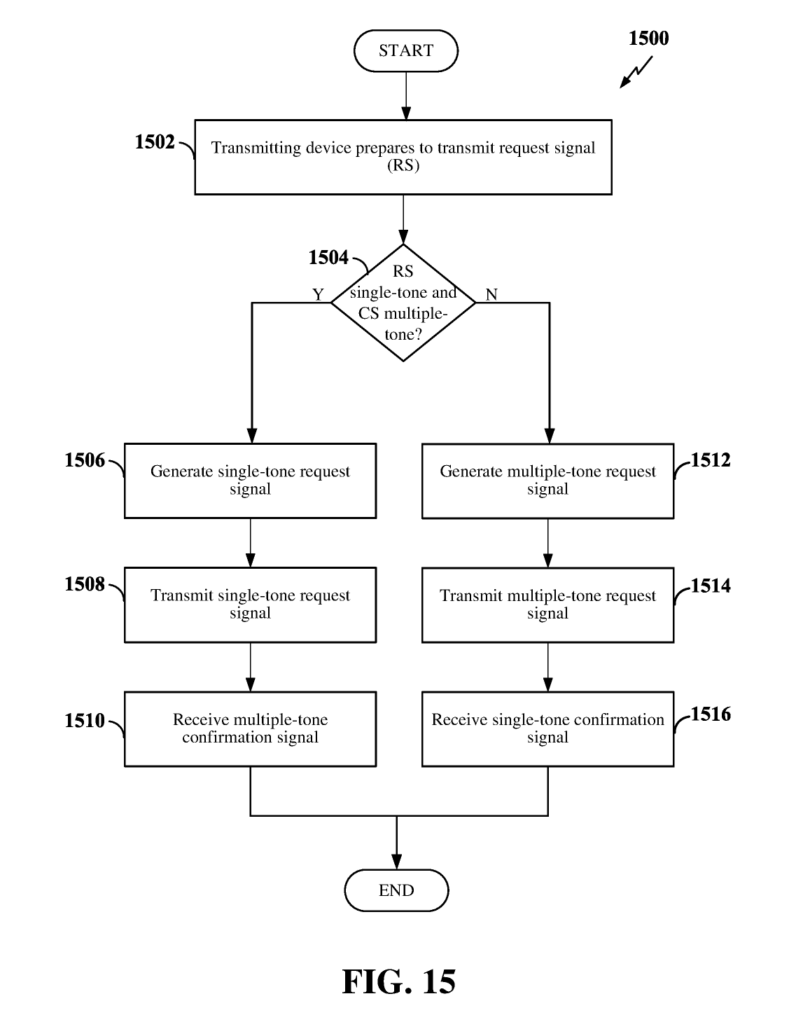

FIG. 15 is a flow chart illustrating an exemplary process 1500 for single-tone and multiple-tone sidelink signaling in accordance with some aspects of the present disclosure. As described below, some or all illustrated features may be omitted in a particular implementation within the scope of the present disclosure, and some illustrated features may not be required for implementation of all embodiments. In the following description, a sidelink signal transmission is discussed with reference to a transmitting sidelink device and a receiving sidelink device. It will be understood that either device may be the user equipment 126 and/or 128 illustrated in FIG. 1; the scheduling entity 202 illustrated in FIGS. 2 and 3; and/or the scheduled entity 204 illustrated in FIGS. 2 and 4. In some examples, the process 1500 may be carried out by any suitable apparatus or means for carrying out the functions or algorithm described below.

At block 1502, the transmitting sidelink device may prepare to transmit a request signal (RS) to a receiving sidelink device. At block 1504, the transmitting sidelink device may determine whether the request signal (e.g., one or both of the DSS and/or STS) should be a single-tone signal or a multiple-tone signal. In addition, the transmitting sidelink device may determine whether a confirmation signal (CS) (e.g., the DRS) should be a single-tone signal or a multiple-tone signal. In some examples, the transmitting and receiving sidelink devices may negotiate whether the request signal (e.g., one or both of the DSS and/or STS) and/or the confirmation signal may be single-tone or multiple-tone signals during the initial association therebetween. In other examples, the network (e.g., scheduling entity) may indicate whether the request signal and confirmation signal should be single-tone or multiple-tone signals.

For example, if the STS and DRS signals each require digital signaling to provide sufficient reliability of the information transmitted in the STS and DRS signals, the DSS signal may be selected to be a single-tone signal. However, if the duration of sidelink transmissions is fixed, and therefore, known by both the transmitting and receiving sidelink devices, both the DSS and STS may be selected to be single-tone signals. The determination of whether the STS should be a single-tone signal or a multiple-tone signal may also be based upon whether the DRS should be single-tone or multiple-tone. For example, if the sidelink signal transmit power and MCS are fixed between the transmitting and receiving sidelink devices, the DRS may be selected to be a single-tone signal. In some examples, if the DRS is selected to be a single-tone signal, at least the STS may be selected to be a multiple-tone signal to provide for reliable destination ID information and Rx-yielding for other links. For example, the processing circuit 444 shown and described above in reference to FIG. 4 may determine whether the request signal(s) and confirmation signal should be single-tone or multiple-tone.

If the request signal includes a single-tone signal (e.g., at least one of the DSS and/or STS is a single-tone signal) and the confirmation signal is a multiple-tone signal (Y branch of 1504), the process proceeds to block 1506, where the transmitting sidelink device may generate the single-tone request signal. In some examples, when the STS is a single-tone signal, the transmitting and receiving sidelink devices may each be identified using a tone ID, and the transmitting sidelink device may generate the STS using the tone ID of the receiving sidelink device. For example, the processing circuit 444 shown and described above in reference to FIG. 4 may generate the single-tone request signal.

At block 1508, the transmitting sidelink device may then transmit the single-tone request signal to the receiving sidelink device. In some examples, the transmitting sidelink device transmits both the DSS and STS, at least one of which is a single-tone signal. In other examples, the transmitting sidelink device transmits a single-tone STS, while another sidelink device transmits a single-tone DSS or multiple-tone DSS when the transmitting sidelink device is not the primary sidelink device. For example, the communication circuit 442 and transceiver 410 shown and described above in reference to FIG. 4 may transmit the single-tone request signal.

At block 1510, the transmitting sidelink device may then receive a multiple-tone confirmation signal from the receiving sidelink device. In some examples, the multiple-tone confirmation signal may include a source ID of the transmitting sidelink device and various link interference management information, such as a transmit power setting to control power backoff (e.g., within a protection zone), the measured SINR of the link, channel quality information (e.g., CQI), and a reference signal to support Tx-yielding. For example, the communication circuit 442 and transceiver 410 shown and described above in reference to FIG. 4 may receive the multiple-tone confirmation signal.

However, if the request signal is not a single-tone signal (e.g., at least the STS) and the confirmation signal (e.g., DRS) is not a multiple-tone signal (N branch of 1504), the process proceeds to block 1512, where the transmitting sidelink device generates a multiple-tone request signal (e.g., at least a multiple-tone STS). In some examples, the STS may be a multiple-tone signal to provide reliable destination information and/or transmission duration information. For example, the processing circuit 444 shown and described above in reference to FIG. 4 may generate the multiple-tone request signal.

At block 1514, the transmitting sidelink device may then transmit the multiple-tone request signal to the receiving sidelink device. In some examples, the transmitting sidelink device transmits both the DSS and STS, where at least the STS is a multiple-tone signal. In other examples, the transmitting sidelink device transmits a multiple-tone STS, while another sidelink device transmits a single-tone DSS or multiple-tone DSS when the transmitting sidelink device is not the primary sidelink device. For example, the communication circuit 442 and transceiver 410 shown and described above in reference to FIG. 4 may transmit the multiple-tone request signal.

At block 1516, the transmitting sidelink device may then receive a single-tone confirmation signal from the receiving sidelink device. In some examples, as described above, the confirmation signal may be single-tone when the sidelink signal transmit power and MCS are fixed between the transmitting and receiving sidelink devices. The transmit power of the single-tone confirmation signal may further be set to control dimensions of the protection zone around the receiving sidelink device in order to manage interference of a subsequently transmitted sidelink signal from the transmitting sidelink device to the receiving sidelink device. For example, the communication circuit 442 and transceiver 410 shown and described above in reference to FIG. 4 may receive the single-tone confirmation signal.

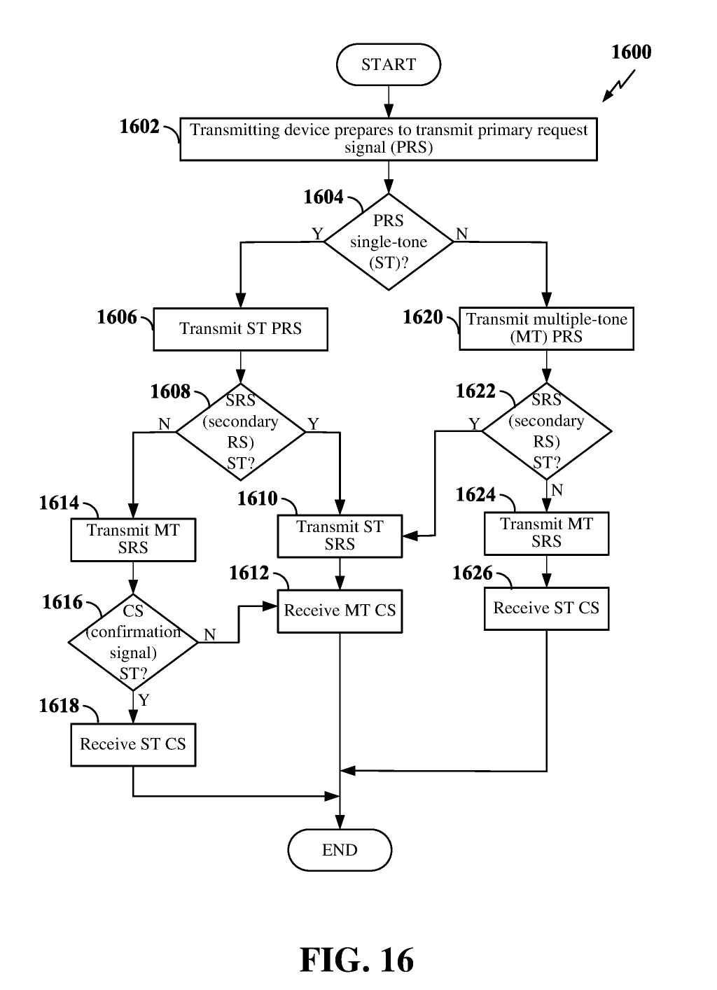

FIG. 16 is a flow chart illustrating another exemplary process 1600 for single-tone and multiple-tone sidelink signaling in accordance with some aspects of the present disclosure. As described below, some or all illustrated features may be omitted in a particular implementation within the scope of the present disclosure, and some illustrated features may not be required for implementation of all embodiments. In the following description, a sidelink signal transmission is discussed with reference to a transmitting sidelink device and a receiving sidelink device. It will be understood that either device may be the user equipment 126 and/or 128 illustrated in FIG. 1; the scheduling entity 202 illustrated in FIGS. 2 and 3; and/or the scheduled entity 204 illustrated in FIGS. 2 and 4. In some examples, the process 1600 may be carried out by any suitable apparatus or means for carrying out the functions or algorithm described below.

At block 1602, the transmitting sidelink device may prepare to transmit a primary request signal (PRS), such as a DSS, to a receiving sidelink device. At block 1604, the transmitting sidelink device may determine whether the DSS should be a single-tone signal or a multiple-tone signal. For example, the processing circuit 444 shown and described above in reference to FIG. 4 may determine whether the primary request signal should be single-tone or multiple-tone.

If the DSS is a single-tone signal (Y branch of 1604), the process proceeds to block 1606, where the transmitting sidelink device may generate and transmit the single-tone DSS. For example, the processing circuit 444, communication circuit 442 and transceiver 410 shown and described above in reference to FIG. 4 may generate and transmit the single-tone DSS. At block 1608, the transmitting sidelink device may then determine whether a secondary request signal (SRS), such as an STS, should be a single-tone signal or a multiple-tone signal. For example, the processing circuit 444 shown and described above in reference to FIG. 4 may determine whether the secondary request signal should be single-tone or multiple-tone.

If the STS is a single-tone signal (Y branch of 1608), the process proceeds to block 1610, where the transmitting sidelink device may generate and transmit the single-tone STS. In some examples, when the STS is a single-tone signal, the transmitting and receiving sidelink devices may each be identified using a tone ID, and the transmitting sidelink device may generate the STS using the tone ID of the receiving sidelink device. For example, the processing circuit 444, communication circuit 442 and transceiver 410 shown and described above in reference to FIG. 4 may generate and transmit the single-tone STS.

At block 1612, the transmitting sidelink device may then receive a multiple-tone confirmation signal (CS), such as a DRS, from the receiving sidelink device. In some examples, the multiple-tone DRS may include a source ID of the transmitting sidelink device and various link interference management information, such as a transmit power setting to control power backoff (e.g., within a protection zone), the measured SINR of the link, channel quality information (e.g., CQI), and a reference signal to support Tx-yielding. For example, the communication circuit 442 and transceiver 410 shown and described above in reference to FIG. 4 may receive the multiple-tone confirmation signal.

However, if the STS is not a single-tone signal (N branch of 1608), the process proceeds to block 1614, where the transmitting sidelink device generates and transmits a multiple-tone STS. In some examples, the STS may be a multiple-tone signal to provide reliable destination information and/or transmission duration information. For example, the processing circuit 444, communication circuit 442 and transceiver 410 shown and described above in reference to FIG. 4 may generate and transmit the multiple-tone STS.

At block 1616, the transmitting sidelink device may then determine whether a confirmation signal (CS), such as the DRS, should be a single-tone signal or a multiple-tone signal. For example, the processing circuit 444 shown and described above in reference to FIG. 4 may determine whether the confirmation signal should be single-tone or multiple-tone.

If the DRS is a single-tone signal (Y branch of 1616), the process proceeds to block 1618, where the transmitting sidelink device receives a single-tone DRS from the receiving sidelink device. In some examples, as described above, the DRS may be single-tone when the sidelink signal transmit power and MCS are fixed between the transmitting and receiving sidelink devices. The transmit power of the single-tone DRS may further be set to control dimensions of the protection zone around the receiving sidelink device in order to manage interference of a subsequently transmitted sidelink signal from the transmitting sidelink device to the receiving sidelink device. For example, the communication circuit 442 and transceiver 410 shown and described above in reference to FIG. 4 may receive the single-tone confirmation signal.

However, if the confirmation signal is not a single-tone signal (N branch of 1616), the process proceeds to block 1612, where the transmitting sidelink device receives a multiple-tone confirmation signal (e.g., multiple-tone DRS) from the receiving sidelink device. For example, the communication circuit 442 and transceiver 410 shown and described above in reference to FIG. 4 may receive the multiple-tone confirmation signal.

Returning to decision block 1604, if the primary reference signal (PRS), such as the DSS, is not a single-tone signal (N branch of 1604), the process proceeds to block 1620, where the transmitting sidelink device may generate and transmit a multiple-tone DSS. In some examples, the DSS may be multiple-tone to include a reference signal enabling channel estimation at the receiving sidelink device. For example, the processing circuit 444, communication circuit 442 and transceiver 410 shown and described above in reference to FIG. 4 may generate and transmit the multiple-tone DSS.

At block 1622, the transmitting sidelink device may then determine whether the secondary request signal (SRS), such as the STS, should be a single-tone signal or a multiple-tone signal. For example, the processing circuit 444 shown and described above in reference to FIG. 4 may determine whether the secondary request signal should be single-tone or multiple-tone. If the STS is a single-tone signal (Y branch of 1622), the process proceeds to block 1610, where the transmitting sidelink device may generate and transmit the single-tone STS. At block 1612, the transmitting sidelink device may then receive a multiple-tone confirmation signal (CS), such as a DRS, from the receiving sidelink device.

However, if the STS is not a single-tone signal (N branch of 1622), the process proceeds to block 1624, where the transmitting sidelink device generates a multiple-tone STS. For example, the processing circuit 444, communication circuit 442 and transceiver 410 shown and described above in reference to FIG. 4 may generate and transmit the multiple-tone STS. At block 1626, the transmitting sidelink device may then receive a single-tone confirmation signal (e.g., single-tone DRS) from the receiving sidelink device. For example, the communication circuit 442 and transceiver 410 shown and described above in reference to FIG. 4 may receive the single-tone confirmation signal. Although blocks 1606/1620 and 1610/1614/1624 are described above as being performed by the same sidelink device, in other examples, block 1606/1620 may be performed by another sidelink device when the transmitting sidelink device is not the primary sidelink device.

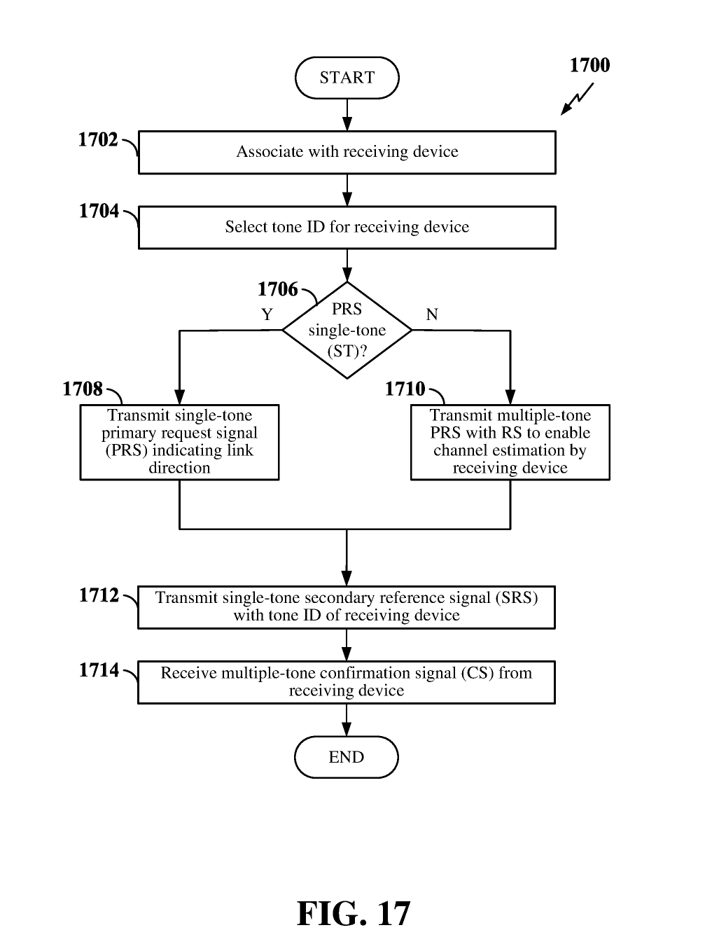

FIG. 17 is a flow chart illustrating an exemplary process 1700 for utilizing a single-tone request signal in sidelink communications in accordance with some aspects of the present disclosure. As described below, some or all illustrated features may be omitted in a particular implementation within the scope of the present disclosure, and some illustrated features may not be required for implementation of all embodiments. In the following description, a sidelink signal transmission is discussed with reference to a transmitting sidelink device and a receiving sidelink device. It will be understood that either device may be the user equipment 126 and/or 128 illustrated in FIG. 1; the scheduling entity 202 illustrated in FIGS. 2 and 3; and/or the scheduled entity 204 illustrated in FIGS. 2 and 4. In some examples, the process 1700 may be carried out by any suitable apparatus or means for carrying out the functions or algorithm described below.

At block 1702, the transmitting sidelink device may associate with a receiving sidelink device, and at block 1704, select a tone ID for the receiving sidelink device. For example, a peer discovery mechanism may be used by an initiating device (e.g., the transmitting or receiving sidelink device) to discover the presence of other devices in a neighborhood or area (e.g., within a radial distance from the location of the initiating device). Once another device of interest is discovered, the initiating device may page the device of interest to associate with the other device and establish a sidelink between the two devices. As part of the association, respective tone IDs may be selected for each device to enable single-tone signaling therebetween. In some examples, the tone IDs may be selected by the initiating device or primary device. In other examples, the tone IDs may be negotiated between the devices. For example, the communication circuit 442, processing circuit 444, and transceiver 410 shown and described above in reference to FIG. 4 may associate with the receiving sidelink device and select the tone ID for the receiving sidelink device.

At block 1706, the transmitting sidelink device may determine whether a primary request signal (PRS), such as a DSS, should be a single-tone signal or a multiple-tone signal. For example, the processing circuit 444 shown and described above in reference to FIG. 4 may determine whether the primary request signal should be single-tone or multiple-tone.

If the DSS is a single-tone signal (Y branch of 1706), the process proceeds to block 1708, where the transmitting sidelink device may generate and transmit the single-tone DSS to indicate the link direction for a sidelink communication. In some examples, the tone ID of the transmitting sidelink device may further be utilized to generate and transmit the single-tone DSS. However, if the DSS is a multiple-tone signal (N branch of 1706), the process proceeds to block 1710, where the transmitting sidelink device may generate and transit the multiple-tone DSS. In this example, the multiple-tone DSS may indicate not only the link direction, but may also include a reference signal to enable channel estimation at the receiving sidelink device. For example, the processing circuit 444, communication circuit 442 and transceiver 410 shown and described above in reference to FIG. 4 may generate and transmit the single-tone or multiple-tone DSS.

At block 1712, the transmitting sidelink device may then generate and transmit a single-tone secondary reference signal (SRS), such as a single-tone STS, with the tone ID of the receiving sidelink device. In addition, the single-tone STS may be associated with a fixed duration of time for utilizing the sidelink channel For example, the processing circuit 444, communication circuit 442 and transceiver 410 shown and described above in reference to FIG. 4 may generate and transmit the single-tone STS.

At block 1714, the transmitting sidelink device may then receive a multiple-tone confirmation signal (CS), such as a DRS, from the receiving sidelink device. For example, the communication circuit 442 and transceiver 410 shown and described above in reference to FIG. 4 may receive the multiple-tone confirmation signal. Although blocks 1708/1710 and 1712 are described above as being performed by the same sidelink device, in other examples, block 1708/1710 may be performed by another sidelink device when the transmitting sidelink device is not the primary sidelink device.

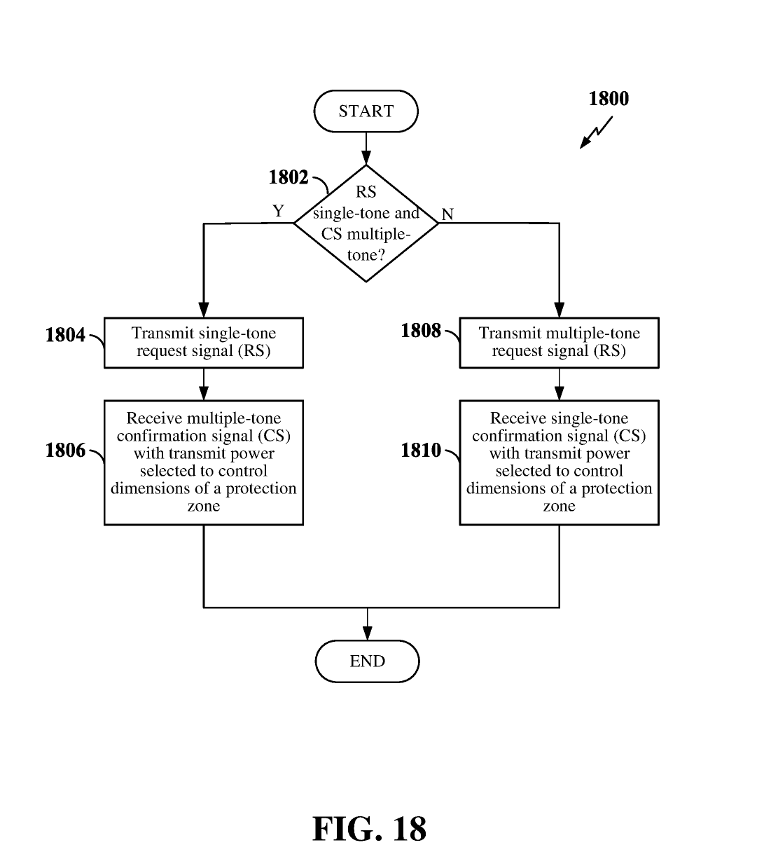

FIG. 18 is a flow chart illustrating an exemplary process 1800 for utilizing single-tone and multiple-tone sidelink signaling to control the dimensions of a protection zone in accordance with some aspects of the present disclosure. As described below, some or all illustrated features may be omitted in a particular implementation within the scope of the present disclosure, and some illustrated features may not be required for implementation of all embodiments. In the following description, a sidelink signal transmission is discussed with reference to a transmitting sidelink device and a receiving sidelink device. It will be understood that either device may be the user equipment 126 and/or 128 illustrated in FIG. 1; the scheduling entity 202 illustrated in FIGS. 2 and 3; and/or the scheduled entity 204 illustrated in FIGS. 2 and 4. In some examples, the process 1800 may be carried out by any suitable apparatus or means for carrying out the functions or algorithm described below.

At block 1802, the transmitting sidelink device may determine whether the request signal (RS) (e.g., one or both of the DSS and/or STS) should be a single-tone signal or a multiple-tone signal. In addition, the transmitting sidelink device may determine whether the confirmation signal (CS) (e.g., DRS) should be a single-tone signal or a multiple-tone signal. In some examples, the transmitting and receiving sidelink devices may negotiate whether the request signal (e.g., one or both of the DSS and/or STS) and/or the confirmation signal may be single-tone or multiple-tone signals during the initial association therebetween. In other examples, the network (e.g., scheduling entity) may indicate whether the request signal and confirmation signal should be single-tone or multiple-tone signals. For example, the processing circuit 444 shown and described above in reference to FIG. 4 may determine whether the request signal should be single-tone and the confirmation signal should be multiple-tone.

If the request signal includes a single-tone signal (e.g., at least one of the DSS and/or STS is a single-tone signal) and the confirmation signal is a multiple-tone signal (Y branch of 1802), the process proceeds to block 1804, where the transmitting sidelink device may generate and transmit the single-tone request signal. In some examples, the transmitting sidelink device transmits both the DSS and STS, at least one of which is a single-tone signal. In other examples, the transmitting sidelink device transmits a single-tone STS, while another sidelink device transmits a single-tone DSS or multiple-tone DSS when the transmitting sidelink device is not the primary sidelink device. For example, the processing circuit 444, communication circuit 442 and transceiver 410 shown and described above in reference to FIG. 4 may generate and transmit the single-tone request signal.

At block 1806, the transmitting sidelink device may then receive a multiple-tone confirmation signal from the receiving sidelink device. In some examples, the multiple-tone confirmation signal may include a transmit power selected to control the dimensions of a protection zone around the receiving sidelink device, thus managing interference for the sidelink signal. For example, the communication circuit 442 and transceiver 410 shown and described above in reference to FIG. 4 may receive the multiple-tone confirmation signal.

However, if the request signal is not a single-tone signal (e.g., at least the STS is not a single-tone signal) and the confirmation signal (e.g., DRS) is not a multiple-tone signal (N branch of 1802), the process proceeds to block 1808, where the transmitting sidelink device generates a multiple-tone request signal (e.g., at least a multiple-tone STS). In some examples, the transmitting sidelink device transmits both the DSS and STS, where at least the STS is a multiple-tone signal. In other examples, the transmitting sidelink device transmits a multiple-tone STS, while another sidelink device transmits a single-tone DSS or multiple-tone DSS when the transmitting sidelink device is not the primary sidelink device. For example, the processing circuit 444, communication circuit 442 and transceiver 410 shown and described above in reference to FIG. 4 may generate and transmit the multiple-tone request signal.

At block 1810, the transmitting sidelink device may then receive a single-tone confirmation signal from the receiving sidelink device. In some examples, the single-tone confirmation signal may include a transmit power selected to control the dimensions of a protection zone around the receiving sidelink device, thus managing interference for the sidelink signal. For example, the communication circuit 442 and transceiver 410 shown and described above in reference to FIG. 4 may receive the single-tone confirmation signal.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-4 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of sidelink wireless communication, comprising:
transmitting a request signal indicating a requested duration of time for a transmitting device to utilize a sidelink channel to transmit a sidelink signal; and
receiving a confirmation signal from a receiving device indicating availability of the sidelink channel for the requested duration of time;
wherein one of the request signal or the confirmation signal comprises a single-tone signal and the other comprises a multiple-tone signal.

2. The method of claim 1, wherein transmitting the request signal further comprises:
transmitting the request signal comprising a primary request signal and a secondary request signal.

3. The method of claim 2, wherein the secondary request signal comprises the single-tone signal, and wherein transmitting the request signal comprising the primary request signal and the secondary request signal further comprises:
transmitting the primary request signal when the transmitting device is a primary device to indicate link direction.

4. The method of claim 3, wherein the primary request signal comprises an additional single-tone signal, and wherein transmitting the request signal comprising the primary request signal and the secondary request signal further comprises:
transmitting the secondary request signal comprising a destination identifier (ID) of the receiving device.

5. The method of claim 4, wherein transmitting the secondary request signal comprising the destination ID of the receiving device further comprises:
transmitting the secondary reference signal comprising a tone ID indicating the destination ID.

6. The method of claim 5, further comprising:
associating with the receiving device; and
selecting the tone ID for the receiving device.

7. The method of claim 4, wherein the requested duration of time is fixed.

8. The method of claim 4, wherein the confirmation signal comprises the multiple-tone signal, and wherein receiving the confirmation signal from the receiving device indicating availability of the sidelink channel for the requested duration of time further comprises:
receiving channel quality information (CQI) from the receiving device in the confirmation signal.

9. The method of claim 3, wherein the confirmation signal comprises the multiple-tone signal and the primary request signal comprises an additional multiple-tone signal, and wherein transmitting the request signal comprising the primary request signal and the secondary request signal further comprises:
transmitting the primary request signal comprising a reference signal to enable channel estimation by the receiving device.

10. The method of claim 3, wherein receiving the confirmation signal from the receiving device indicating availability of the sidelink channel for the requested duration of time further comprises:
receiving the confirmation signal comprising one or more of a signal-to-interference-plus-noise ratio (SINR), channel quality information, a reference signal or a power setting selected to control dimensions of a protection zone and manage interference for the sidelink signal.

11. The method of claim 2, wherein the secondary request signal comprises the multiple-tone signal and the confirmation signal comprises the single-tone signal, and wherein receiving the confirmation signal from the receiving device indicating availability of the sidelink channel for the requested duration of time further comprises:
receiving the confirmation signal with a power set by the receiving device to control dimensions of a protection zone and manage interference for the sidelink signal.

12. The method of claim 2, wherein the secondary request signal comprises the multiple-tone signal, the primary request signal comprises an additional multiple-tone signal and the confirmation signal comprises the single-tone signal.

13. A device for sidelink wireless communication, the device comprising:
a processor;
a transceiver communicatively coupled to the processor; and
a memory communicatively coupled to the processor, wherein the processor is configured to:
transmit a request signal indicating a requested duration of time for the first device to utilize a sidelink channel to transmit a sidelink signal; and
receive a confirmation signal from an additional device indicating availability of the sidelink channel for the requested duration of time;
wherein one of the request signal or the confirmation signal comprises a single-tone signal and the other comprises a multiple-tone signal.

14. The device of claim 13, wherein the request signal comprises a primary request signal and a secondary request signal, and wherein the processor is further configured to:
transmit the primary request signal when the device is a primary device to indicate link direction.

15. The device of claim 14, wherein:
the secondary request signal comprises the single-tone signal;
the primary request signal comprises an additional single-tone signal; and
the secondary request signal comprises a tone identifier (ID) indicating a destination identifier ID of the additional device.

16. The device of claim 15, wherein the confirmation signal comprises the multiple-tone signal, and wherein the confirmation signal comprises one or more of a signal-to-interference-plus-noise ratio (SINR), channel quality information, a reference signal or a power setting selected to control dimensions of a protection zone and manage interference for the sidelink signal.

17. The device of claim 14, wherein:
the secondary request signal comprises the multiple-tone signal;
the confirmation signal comprises the single-tone signal; and
the confirmation signal comprises a power set by the additional device to control dimensions of a protection zone and manage interference for the sidelink signal.

18. An apparatus for sidelink wireless communication, the apparatus comprising:
means for transmitting a request signal indicating a requested duration of time for a transmitting device to utilize a sidelink channel to transmit a sidelink signal; and
means for receiving a confirmation signal from a receiving device indicating availability of the sidelink channel for the requested duration of time;
wherein one of the request signal or the confirmation signal comprises a single-tone signal and the other comprises a multiple-tone signal.

19. The apparatus of claim 18, wherein:
the request signal comprises the single-tone signal;
the request signal comprises a tone identifier (ID) indicating a destination identifier ID of the second device;
the confirmation signal comprises the multiple-tone signal; and
the confirmation signal comprises one or more of a signal-to-interference-plus-noise ratio (SINR), channel quality information, a reference signal or a power setting selected to control dimensions of a protection zone and manage interference for the sidelink signal.

20. The apparatus of claim 18, wherein:
the request signal comprises the multiple-tone signal;
the confirmation signal comprises the single-tone signal; and
the confirmation signal comprises a power set by the receiving device to control dimensions of a protection zone and manage interference for the sidelink signal.
